(19) United States
(12) Patent Application Publication
(10) Pub. No.: US 2026/0362283 A1
(43) Pub. Date: Nov. 12, 2026

(54) METHODS AND DEVICES FOR DISAGGREGATED RADIO ACCESS NETWORKS

(71) Applicant: Intel Corporation, Santa Clara, CA (US)

(72) Inventors: Kuilin Clark CHEN, Portland, OR (US); Lu LU, Hillsboro, OR (US); Thushara HEWAVITHANA, Chandler, AZ (US); Xiaowen ZHANG, Shanghai (CN)

(21) Appl. No.: 19/488,647

(22) PCT Filed: Dec. 29, 2023
(86) PCT No.: PCT/CN2023/143045

§ 371 Date: Nov. 28, 2025

(51) Int. Cl. H04W 40/06

(52) U.S. Cl. CPC H04W 40/06

(57) ABSTRACT

An apparatus of an intermediate node of an open radio access network (O-RAN), the apparatus may include an interface configured to provide communication between a plurality of O-RAN radio units (O-RUs) and a plurality of O-RAN distributed units (O-DUs); and a processor configured to: determine a network unit pair comprising a O-RU of the plurality of O-RUs and a O-DU of the plurality of O-DUs for a data stream of a plurality of data streams to be communicated between the plurality of O-RUs and the plurality of O-DUs; and route, based on the determined network unit pair, the data stream between the O-RUs and the O-DU.

### TECHNICAL FIELD

This disclosure generally relates to methods and devices for disaggregated radio access networks.

### BACKGROUND

In radio communication networks in accordance with many radio communication technologies, such as Fourth Generation (LTE) and Fifth Generation (5G) New Radio (NR), various methods are employed to provide wireless data transfer with desired efficiency, speed, and reliability. Traditional radio access networks (RANs) employed integrated systems in which the entire processing with respect to transmission and reception of radio communication signals was performed. In such traditional RANs, network access nodes may implement the whole network stack including physical layer (PHY), media access control (MAC), radio link control (RLC), and packet data convergence control (PDCP).

In various deployments in recently emerged RAN architectures, such as Open Radio Access Network (O-RAN) architectures, network access nodes may have functionalities that are split among multiple units with an intention to meet the demands of increased capacity requirements by providing a flexible and interoperable approach for RANs. There are many approaches to provide the split among the multiple units. In one example, a baseband unit (BBU) may be split into i) a Control Unit (CU) (e.g. O-CU) mainly responsible for non-real time operations hosting the radio resource control (RRC) and the control plane of the PDCP protocol and a ii) Distributed Unit (DU) (e.g. O-DU) mainly responsible for real-time operations hosting, for example, RLC layer functions, MAC layer functions, and Higher-PHY functions. Radio units (RUs) (e.g. O-RU) hosting the Lower-PHY functions may receive radio communication signals from terminal devices and provide data streams to the DU over a fronthaul interface (e.g. open fronthaul).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an illustrative example associated with a network access node;

FIG. 4 shows an example of a radio communication network;

FIG. 5 shows an illustrative example of a baseband processing entity and a radio unit;

FIG. 6 shows an exemplary illustration of a disaggregated radio access network;

FIG. 7 shows an example of a device;

FIG. 8 shows an example of a schematically illustration of a processor;

FIG. 9 shows an illustrative example of a radio access network;

FIG. 10 shows schematically an example of a processor and a memory to implement an AI/ML;

FIG. 11 show an example of an illustration of processing of communication data for a UE in a disaggregated radio access network;

FIG. 12 show an example of an illustration of processing of communication data for a UE in a disaggregated radio access network;

FIG. 13 show an example of an illustration of processing of communication data for a UE in a disaggregated radio access network;

FIG. 14 shows an exemplary radio access network architecture in which the radio access network is disaggregated into multiple units;

FIG. 15 shows an example of a method.

### DESCRIPTION

The following detailed description refers to the accompanying drawings that show, by way of illustration, exemplary details and aspects in which aspects of the present disclosure may be practiced.

In conventional cellular systems like 2G/3G, the signal processing for each cell is restricted to fixed hardware resources such as BTS (Base Transceiver Station). In 3G/4G, a disaggregation of a single radio network access node has been introduced by including RRUs (Remote Radio Unit) and BBUs, which is followed by the O-RAN architecture for 4G/5G/6G, in which the disaggregation involves O-RUs, O-DUs, and O-CUs.

Furthermore, virtualized RAN (vRAN) concept has been introduced, which may also be considered to include aspects associated with the disaggregation and virtualization of various components of the conventional RAN. In the vRAN concept, various functions performed by hardware specific elements are virtualized and converted into software-based functionalities operable on standard hardware platforms. The previously introduced hardware components such as RRUs and BBUs have been separated into software-based entities. The vRAN concept further includes standardized and open interfaces for interoperability between different hardware platforms independent from vendor-specific implementations for a more open and flexible network ecosystem.

Although O-RAN architecture has also employed the vRAN concept, the signal processing for each cell may still be confined to one particular virtual machine instance hosted on semi-fixed hardware resources of a server or a designated computing hardware. In other words, signal processing tasks for users (i.e. user equipments (UEs)) associated with a particular cell may be handled within this one particular virtual machine instance. Although the operation is virtualized and is intended to operate in a more flexible software-based architecture, it is still limited by limitations associated with the hardware platform implementing the software-based architecture, thereby limiting scalability and flexibility in certain conditions.

There are various challenges and outcomes associated with these limitations within the context of virtualized network environments, such as O-RAN architecture, as described below. These challenges may collectively introduce complexities and limitations in efficiently adapting to varying network loads, implementing joint signal processing for enhanced efficiency, and supporting joint massive MIMO transmission in the downlink due to the limitations of existing hardware architectures, signal processing constraints, and the complexities involved in combining and processing multiple data streams in real-time.

One of the challenges may be the adaptability to dynamic network load. Usually, hardware resources associated with the baseband processing at BTS/BBU/O-DU may be configure to support maximum throughput, resulting in inefficient employment of resources, such as computing resources, during low network traffic/low cell load situations, as not all of the available computing resources are utilized.

Furthermore, traditionally one baseband processing entity (e.g. BTS/BBU/O-DU) may be configured to perform signal processing associated to the whole cell, in which the signal processing is fixed and cannot be moved to another baseband processing entity or divided into multiple baseband processing entities. For the vRAN concept, it may be challenging for the virtual machine that may host the signal processing of the vRAN to migrate from one physical machine to another physical machine, as the size of the virtual machine may be at hundreds of megabytes (MBs) or a few gigabytes (GB). Even via an ethernet interface of 100 Gbps, a migration may result in a service interruption of hundreds of milliseconds, which may be deemed as unacceptable for a cellular system with a subframe time duration of 1 ms.

Another challenge may include joint signal processing in Uplink (UL). Within the current architecture, in-phase and quadrature phase (IQ) signals from multiple O-RUs associated with a specific UE need to be routed to one O-DU for joint processing. For this purpose, O-DUs are generally configured to accommodate a considerable amount of vRAN instances simultaneously. However, designing such a large baseband processing entity to handle multiple vRAN instances and aggregate IQ signals may be costly and may affect the efficiency of scalability, considering the number of antennas (e.g. 64 antennas for each O-RU) and the high bandwidth of IQ signals, which may be illustratively 100 Gbps across 3 sectors in a 5G/6G system.

A further challenge may include flexibility constraints for joint massive multiple input multiple output (MIMO) transmission in downlink (DL). It is required to transfer IQ signals from multiple O-DUs to one or more target O-RUs for joint beamforming in DL, which may necessitate the combination of multiple data streams with a particular matrix multiplication operation before they are delivered to the one or more target O-RUs.

In accordance with various aspects described herein, a new hardware architecture may be provided between baseband processing entities and RRUs that may address the above-mentioned challenges while increasing the flexibility in system scalability within the disaggregated network architecture.

In accordance with various aspects described herein, with the new hardware architecture, any RRU signal (RRU/O-RU) may be routed to any baseband processing unit (BBU/O-DU) for transmission (TX) or reception (RX) signal processing. Accordingly, a device may be provided, which is configured to direct/route signals from RUs to various baseband processing entities for handling TX and RX tasks.

In accordance with various aspects described herein, the device may be configured to dynamically change user association to different RU-baseband processing entity pairs, or signal processing resource location at any baseband processing entity or RUs. Accordingly, the device may allocate resources in real-time according to changing network conditions, user demands, cell load, etc. For instance, the device may shift a connection of a UE to another RU or another baseband processing entity to optimize performance or accommodate varying network loads.

In accordance with various aspects described herein, the device may be configured to support workload scalability by scaling up or down. Illustratively, the device may scale up or down processing capacity and resources of the radio access network without causing disruptions on the services ongoingly provided to the UEs.

In accordance with various aspects provided herein, the device may support in-line beamforming and processing for joint transmission and reception. In-line beamforming may refer to performing beamforming or signal processing operations in real-time or near-real time as signals pass through the device. Accordingly, the device may coordinate multiple signals efficiently and may enhance the capacity of the radio access network for joint receiving and transmitting operations.

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10(3rd Generation Partnership Project Release 10), 3GPP Rel. 11(3 rd Generation Partnership Project Release 11), 3GPP Rel. 12(3rd Generation Partnership Project Release 12), 3GPP Rel. 13(3rd Generation Partnership Project Release 13), 3GPP Rel. 14 (3rd Generation Partnership Project Release 14), 3GPP Rel. 15 (3rd Generation Partnership Project Release 15), 3GPP Rel. 16(3rd Generation Partnership Project Release 16), 3GPP Rel. 17(3rd Generation Partnership Project Release 17), 3GPP Rel. 18 (3rd Generation Partnership Project Release 18), 3GPP 4G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 690-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 600 MHz bands, bands within the 24.25-86 GHz range, etc.), spectrum made available under FCC's “Spectrum Frontier” 4G initiative (including 27.5-28.35 GHz, 29.1-29.25 GHz, 31-31.3 GHz, 37-38.6 GHz, 38.6-40 GHz, 42-42.5 GHZ, 47-64 GHz, 64-71 GHz, 61-76 GHz, 81-86 GHz and 92-94 GHz, etc.), the ITS (Intelligent Transport Systems) band of 4.9 GHz (typically 4.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 60.2 GHz- 71 GHz band, any band between 65.88 GHz and 61 GHz, bands currently allocated to automotive radar applications such as 66-81 GHz, and future bands including 94-300 GHz and above. Furthermore, the apparatuses and methods described herein can also employ radio communication technologies on a secondary basis on bands such as the TV White Space bands (typically below 690 MHz) where e.g. the 400 MHz and 600 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

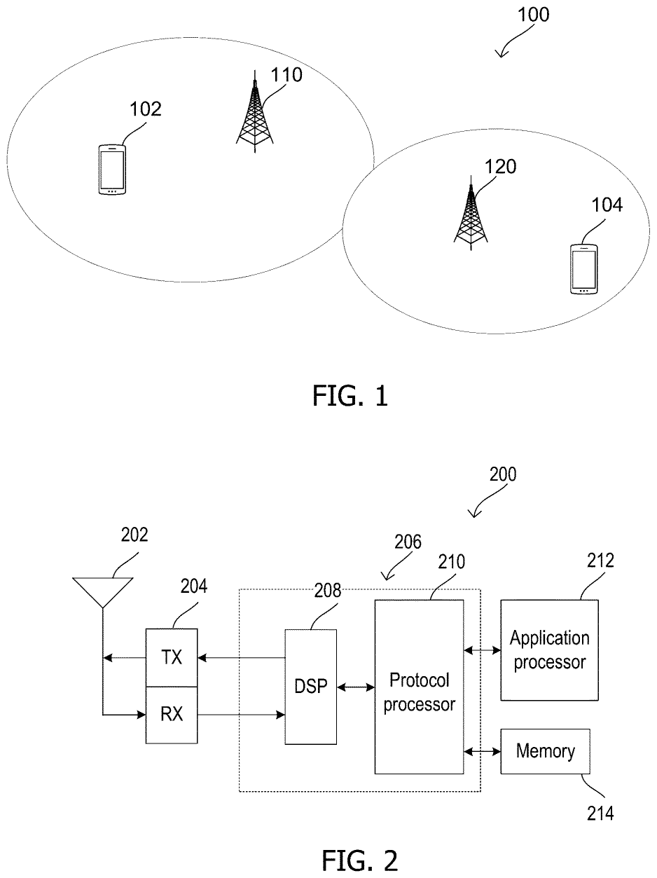

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 (i.e. mobile radio communication devices) via network access nodes 110 and 120 (i.e. radio communication devices) over a radio access network. Although certain examples described herein may refer to a particular radio access network context (e.g., LTE, UMTS, GSM, other 3rd Generation Partnership Project (3GPP) networks, WLAN/WiFi, Bluetooth, 4G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

In various aspects, network access nodes 110 and 120 may include one or more CUs, one or more DU, and one or more RUs to communicate with terminal devices 102 and 104. In various examples, an RU may include a device configured to implement various processing functions for RF. In particular the RU may implement functions of a lower PHY. A DU may include a device configured to implement various processing functions, in particular including functions of a higher PHY, MAC, and RLC. The skilled person may realize that this is one example of a split of the network stack and DUs and RUs may have different split configurations. The RU may be linked to terminal devices 102 and 104 over a radio connection, and to the DU over a fronthaul interface.

In various examples, the fronthaul interface may be according to a Common Public Radio Interface (CPRI) or an Enhanced Common Public Radio Interface (eCPRI) configured to communicate over a connection via fiber optic cables, but there are also other communication mediums that may handle the fronthaul communication. In any event, the RUs may be serving a plurality of terminal devices, and there may be limitations in terms of link capacity and bandwidth with respect to the communication between the RUs and a corresponding DU over the fronthaul. It may desirable to address some of the fronthaul limitations.

It may be desirable to implement massive MIMO to provide extra system capacity with a plurality of antennas (64, or even 128) at the macro base station side, which usually support 8, 12 or even 16 concurrent Uplink/Downlink streams (i.e., antenna ports) at the same time/frequency resources. Due to the limited bandwidth of fronthaul from the antenna array to the BBU, the physical layer signal must be processed in the Radio Unit (RU) or split with certain processing at RU and some other processing in Distributed Unit (DU), as O-RAN defined.

The Coordinated Multi-point transmission/reception (COMP) technique may utilize the joint processing. CoMP may be considered to have two modes, a first mode with an independent eNB architecture that may be referred to as a Coordinated Scheduling/Beamforming (CS/CB) and a second mode that employs a centralized eNB that may be referred to as joint processing (JP). The JP mode may support joint processing in which multiple eNBs may serve to one UE in a joint manner. However, CoMP is based on conventional network architecture, and the information exchange for joint processing may be limiting in some of the coordinated schemes. There may be issues to be addressed in terms of overhead and complexity. It may desirable to address the joint processing for the case with substantial number of antennas in dense scenarios with considerable number of users, where the front-haul constraint becomes the key bottleneck for optimal joint processing in O-RAN.

Furthermore, with separate processing across various cell sectors, in terms of performance (e.g., throughput) there may be limitations with respect to inter-cell and intra-cell interferences. While intra-cell interference may be minimized through beamforming techniques, it may be further desirable to handle inter-cell interferences as well, especially for cell-edge users in dense scenarios. Whitening filters, MMSE-IRC, and Successive Interference Cancellation (SIC) may be employed but the lack of information about the interferences may be limiting in certain scenarios. Accordingly, especially in uplink direction, RU may use a local knowledge for estimation of channel parameters (including self-estimated information or UE-based information such as CSIs). In such cases, it may be desirable to share the capability of interference cancellation between the RU and the DU.

In this disclosure, various precoding schemes for joint processing are provided. Various traditional communication networks are designed with a network centric approach that may provide non-uniform performance due to cell-center and cell-edge experiencing different SINR, owing to the fixed cell or sector boundaries. Cell Free Massive MIMO is an emerging paradigm in which effects of such cell/sector boundaries may be reduced or eliminated and a user-centric design approach can be formulated. To this end, joint processing of signals corresponding to multiple RUs may be considered one of the main problems known to enable Cell-free Massive MIMO as well as CoMP-JT (Joint Transmission in CoMP).

FIG. 2 shows an exemplary internal configuration of a communication device according to various aspects provided in this disclosure. The communication device may include various aspects of radio communication devices (e.g. network access nodes 110, 120) or various aspects of mobile radio communication devices (e.g. terminal device 102, 104) as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAS), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select\available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

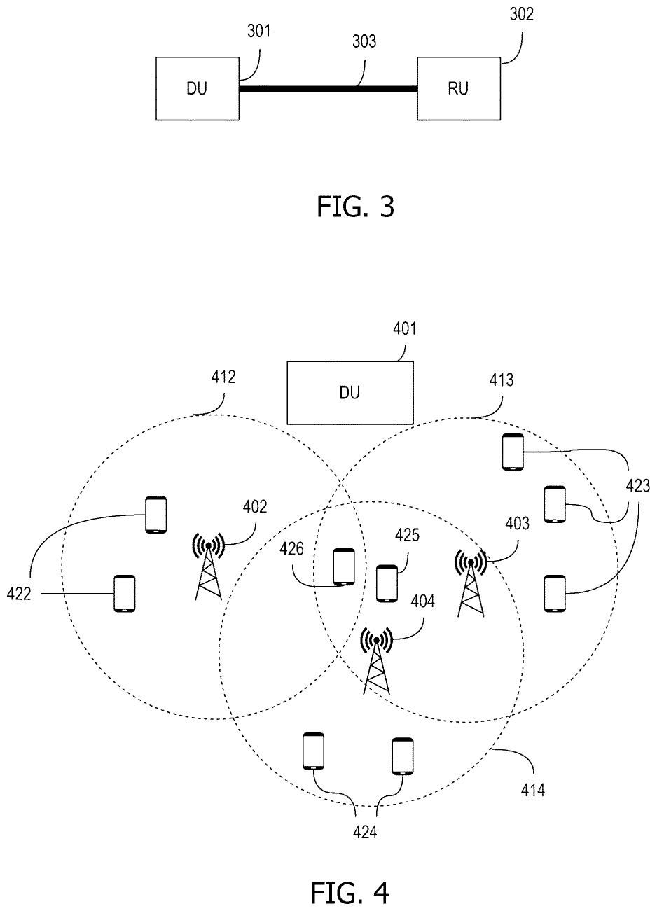

FIG. 3 shows an illustrative example associated with a network access node. The illustration shows a network access node system including a DU 301 and an RU 302. A fronthaul 303 connects the DU 301 and the RU 302. An interface, such as CPRI or eCPRI may be used with as a fronthaul interface. As provided in this disclosure, the DU 301 may implement various functions for PDCP, RLC, MAC, and PHY layer, and the RU 302 may implement various functions for the PHY layer and RF functions to receive and transmit radio communication signals to terminal devices (i.e. UEs) that are communicatively coupled to the RU 302. The term “communicatively coupled to” may also be referred to as “attached to” or “serve”. The illustration shows that there is only one RU 302 is communicatively coupled to the DU 301, but the skilled person would appreciate that the DU 301 may be communicatively coupled to a plurality of RUs.

Illustratively, in particular according to O-RAN context, the DU 301, when combined with the RU 302 connected to it, may provide functions of a gNB-DU as defined by 3GPP TS 38.401. Noting that the DU 301 may be a virtual (i.e. logical) entity, or a physical entity, the DU 301 may terminate the E2 and the F1 interface, and the Open Fronthaul interface as well as the RLC, MAC and High-PHY functions of the radio interface towards the UE.

The DU 301 may perform various functions in the PHY layer that may be different from the PHY layer functions that the RU 302 performs. The DU 301 may be deployed close to the RU 302 on site on a commercial off-the-shelf (COTS) server and communicate with the RU 302 over the fronthaul 303. For example, in a system configuration with a 7-2 functional split, the DU 301 may perform higher PHY layer functions including precoding on antenna ports, layer mapping, modulation, scrambling, rate matching, coding and block segmentation, cyclic redundancy check (CRC) functions and the RU 302 may perform lower PHY layer functions including cyclic prefix (CP) functions, Fast Fourier Transform (FFT) functions, beamforming and port expansion functions, resource element mapping functions. The RU 302 may also perform RF functions. In various examples, the DU 301 and the RU 302 may be configured to operate with various functional split configurations, in particular different configurations for downlink and uplink.

Accordingly, the RU 302 may include a transceiver configured to receive and transmit radio communication signal to a plurality of terminal devices that the RU 302 may serve (e.g. UEs). The RU 302 may include or may be coupled to a plurality of antennas (e.g. an antenna array) to receive and transmit radio communication signals to the terminal devices. The RU 302 may perform beamforming operations (e.g. by applying beamforming weights) to communicate with the terminal devices. In various examples, the RU 302 may receive radio communication signals from the terminal devices and obtain baseband signals based on the received radio communication signals in the uplink. The RU 302 may further obtain radio communication signals from baseband signals and transmit radio communication signals to the terminal devices in the downlink.

The RU 302 may further include a processor configured to perform various processing functions, in particular with respect to the defined network stack functions for the RU 302. As provided for this illustrative example, the processor of the RU 302 may implement lower-PHY functions including the functions as provided for the illustrative example. Furthermore, the processor of the RU 302 may include a controller to perform various aspects as provided in this disclosure. The RU 302 may further include a memory to store data.

The transceiver of the RU 302 may further perform operations to communicate with the DU 301. The transceiver of the RU 302 may include circuits to receive and transmit communication signals from/to the DU 301 over the fronthaul 303. Accordingly, the processor of the RU 302 may control a fronthaul interface and transmit communication signals based on the received radio communication signals after the RU 302 performs the defined lower-PHY functions to the DU 301 over the fronthaul 303, so that the DU 301 may further process the communication signals that the RU 302 provides according to various functions designated for the DU 301. Similarly, the DU 301 may perform various processing functions designated for the DU 301 and transmit communication signals to be transmitted to the terminal devices to the RU 302 over the fronthaul 303, and the RU 302 may perform defined lower-PHY functions and also RF functions for the communication signals in order to transmit radio communication signals to the terminal devices.

The DU 301 may include a transceiver configured to receive and transmit communication signals from/to the RU 302 over the fronthaul 303. Furthermore, the transceiver of the DU 301 may transmit and receive signals from a control unit (not shown) that performs various functions of the network stack over a backhaul or a midhaul. In various examples, a combined unit (e.g. a BBU) may include the DU 301, so that the RU 302 may be communicatively coupled to the BBU over a fronthaul.

The DU may include a processor configured to perform various processing functions, in particular with respect to the defined network stack functions for the DU 301. As provided for this illustrative example, the processor of the DU 301 may implement RLC layer functions, MAC layer functions, and higher-PHY functions including the functions as provided for this illustrative example. Furthermore, the processor of the DU 301 may include a controller to perform various aspects as provided in this disclosure. The DU 301 may further include a memory store data.

In accordance with various aspects described herein, the illustrated connection, via the fronthaul 303, may facilitate bidirectional data transfer between the DU 301 providing handling of higher network stack functionalities, and the RU 302 focusing on lower PHY layer operations. Illustratively, the RU 302 may perform primary functions, such as cyclic prefix (CP), FFT, beamforming and RF, including processing baseband signals and radio communication signals received from terminal devices and the DU 301 may manage more complex tasks such as PDCP, RLC, MAC, and higher-layer PHY functions.

Further, the RU 302 may contribute by performing in-line beamforming operations, i.e. applying beamforming weights to facilitate communication with terminal devices. Inherently, such operations may require a collaboration as the RU 302 performs beamforming from signals received from the DU 301 to obtain beamformed communication signals to be transmitted to terminal devices.

In such a disaggregated network architecture, a UE may be associated with both the RU 302, the DU 301 (and further with CU), as these entities provide processing of network stack for uplink and downlink communication signals of the corresponding UE. Illustratively, the RU 302 may be the primary node for interaction with the UE, through receiving, processing, and forwarding radio communication signals of the UE to/from the DU 301 via the fronthaul.

In order to provide network communication service to the UE, the fronthaul 303 may carry data streams of the UE in both uplink and downlink direction. The data streams may refer to the flow of digital information or packets that are transmitted and/or received with the radio access network. In particular, the data streams may carry user data, such as user-generated data, as in voice calls, video streams, internet browsing packets, etc., any such information transmitted or received by terminal devices (e.g. control-plane data). The data streams may further include control signals that are configured to manage and control various operations of the radio access network, such as synchronization information, handover information, etc. (e.g. control-plane data). The data streams may further include network management information associated with management and monitoring of the radio access network (e.g. control-plane data).

It is to be noted that, in MU-MIMO configuration, the data streams carried by the fronthaul 303 may include data of multiple UEs served by the RU 302. Illustratively, the RU 302 may include an antenna array having N number of antennas, and the data streams carried by the fronthaul 303 may include communication signals received from the N number of antennas, or communication signals to be transmitted by the N number of antennas to multiple UEs according to the MU-MIMO arrangement.

FIG. 4 shows an example of a radio communication network. The radio communication network may include a DU 401 that is communicatively coupled to a plurality of RUs, such that each RU of the plurality of RUs coupled to the DU 401 over a fronthaul (not shown), including a first RU 402, a second RU 403, and a third RU 404. Each RU may be located at different locations in order to provide service to different cell sectors, in a manner that each RU may provide service for UEs for a sector that may or may not overlap with another cell sector of another RU. In this example, the first RU 402 is configured to provide service for UEs in a first sector 412, a second RU 403 is configured to provide service for UEs in a second sector 413, and a third RU is configured to provide service for UEs in a third sector 414, and the cell sectors may overlap at certain locations. In various examples, each RU may be configured to provide services for substantially the same coverage area to multiple UEs, in which each of the UEs may be served by more than one RU for joint processing.

Accordingly, each RU may be serving a plurality of UEs within the respective sector of the RU to receive and transmit radio communication signals from/to UEs. In this illustrative example, the first RU 402 is configured to provide services for a first group of UEs including UEs 422 and the UE 426, and it may be referred to as the first group of UEs 422 are served by the first RU 402. The term served for this aspect may refer to a case of an existent radio connection between entities, or a case where UEs receive services at least for a function of a layer of an interconnection model with respect to the network stack. This may include a case where the first RU 402 serves to the first group of UEs 422, such as the first RU 402 may be a serving cell for the first group of UEs, and it may be referred to as the first group of UEs 422 are being served by the first RU 402, and such. Illustratively, each UE 422 is associated with the first RU 402 and is associated with the DU 401 as a RU-DU pair, which may also be referred to as a network unit pair in this disclosure.

In this context, each of the UE 423 is associated with the second RU 403, and is associated with the DU 401, as a corresponding RU-DU pair. Similarly, each of the UEs 424 is associated with the third RU 404, and is associated with the DU 401, as corresponding RU-DU pair.

As indicated, there may be cases in which there are overlap at certain locations. For this aspect, one of the UEs, i.e. the UE 425 is depicted in such a manner, the UE 425 may be located to receive services in the second cell sector 413 and in the third cell sector 414. In other words, the UE 425 is associated with the second RU 403 and the third RU 404, and is associated with the DU 401. So, the UE 425 is associated with a first RU-DU pair that is the second RU 403 and the DU 401; and is associated with a second RU-DU pair that is the third RU 404 and the DU 401.

Similarly, the UE 426 is depicted to receive services from each of the first RU 402, the second RU 403, and the third RU 404, and hence served by all RUs 402, 403, 404. In other words, the UE 426 is associated with the first RU 402, the second RU 403 and the third RU 404, and is associated with the DU 401. So, the UE 426 is associated with a first RU-DU pair that is the first RU 402 and the DU 401, a second RU-DU pair that is the second RU 403 and the DU 401; and is associated with a third RU-DU pair that is the third RU 404 and the DU 401.

Accordingly, each UE 422, 423, 424, 425 may transmit and receive radio communication signals from/to the corresponding RU 402, 403, 404 that the respective UE 422, 423, 424, 425 is being served. In such a constellation, especially based on the locations of the RUs, each RU may encounter interferences with respect to radio communication activities between other RUs and the corresponding group of UEs. For example, the radio communication between each RU 402, 403, 404, and corresponding groups of UEs as provided in this illustrative example, may be subjected to interference based on radio communication signals exchanged between each of the other RUs 402, 403, 404 and corresponding group of UEs for each of the other RUs 403, 404.

For example, the radio communication between the first RU 402 and the first group of UEs may be subject to interference from radio communication signals exchanged between the second RU 403 and the second group of UEs and between the third RU 404 and the third group of UEs. Accordingly, with respect to the first RU 402, the radio communication between the second RU 403 and the second group of UEs, and the radio communication between the third RU 404 and the third group of UEs may be referred to as interfering radio communication in this example. Similarly, for the first RU 402, other RUs, such as the second RU 403 and the third RU 404 may be referred to as interfering RUs, and the first group of UEs and the second group of UEs may be referred to as interfering UEs (e.g. interfering UEs) in this disclosure. In this illustrative example, as the UE 425 that is served by both of the second RU 403 and the third RU 404, neither interfering UEs for the second RU 403 nor the third RU 404 may include the UE 425, as the UE 425 is being served by the second RU 403 and the third RU 404. In various examples, RUs may receive information indicating further relationship between UEs and other RUs from the corresponding UE that the RU is serving, or from a DU that the RU is communicatively coupled to.

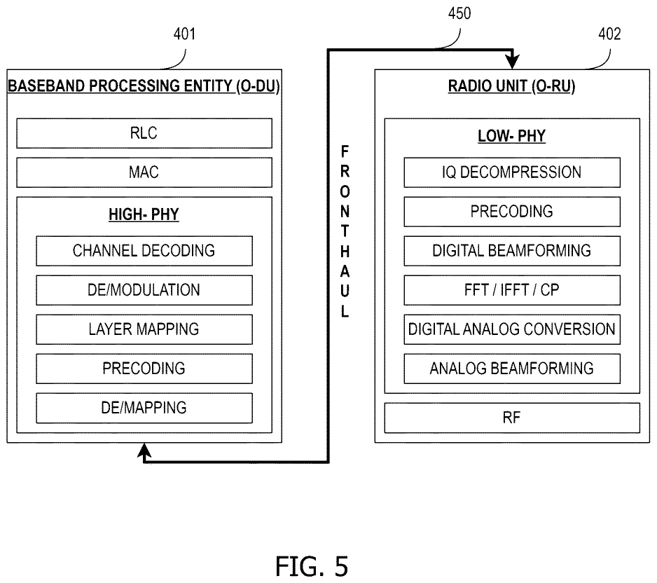

FIG. 5 shows an illustrative example of a baseband processing entity and a radio unit, as exemplary illustrated as RU (e.g. O-DU) 402 and a DU (e.g. O-DU) 401 respectively, together with various functions associated with each entity in accordance with a designated split at the network stack to separate PHY functions of the protocol stack into a LOW-PHY and a HIGH-PHY. In this illustration, the RU 401 may perform RF functions to receive and transmit radio communication signals from UEs, and LOW-PHY functions including analog beamforming, digital to analog or analog to digital conversion, FFT/IFFT and cyclic prefix functions, digital beamforming, precoding, and IQ decompression.

The DU 401 may be coupled to the RU 402 via the fronthaul 450. The DU 401 may perform further PHY functions, as HIGH-PHY functions including remapping, precoding, layer mapping, symbol modulation, and scrambling. The DU may further implement MAC and RLC operations. In some examples, a CU may be communicatively coupled to the DU 401 to perform further network operations above RLC layer, such as RRC, PDCP, SDAP, etc. In some examples, the DU may perform these operations.

Traditionally, in disaggregated radio access network architectures, association of a UE may involve a single baseband processing entity. In accordance with various aspects provided herein, a device may be provided which may allow an association of UE for multiple entities, selectable dynamically in accordance with various aspects described herein. It is to be noted that various aspects described for the device to be implemented in various nodes of the radio communication network, illustratively, by an orchestrating DU, an O-CU, within a RIC (e.g. an near-RT-RIC, a non-RT-RIC), etc. For some of the aspects, the device may be an intermediary node between baseband processing entity-level and RU-level, which is illustrated accordingly to describe the aspects. The skilled person would recognize the embodiments in which it is essential for the device to operate as the intermediary node.

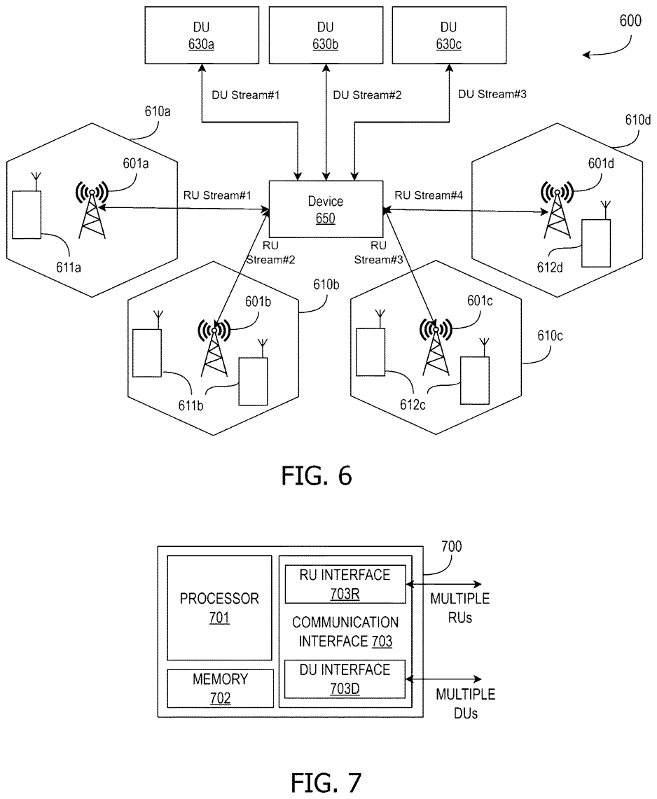

FIG. 6 shows an exemplary illustration of a disaggregated radio access network in accordance with various aspects described herein. The radio access network 600 may include multiple cells. A cell may be referred to as a particular geographical region covered by a radio access node (e.g. radio unit) in which the radio access node provides a network access service to terminal devices. The size of a cell may depend on the mobile radio communication technology used by the radio access node associated with the cell. For example, within the context of a wireless local area network (WLAN), a cell may have a radius of up to 100 meters, while within the context of cellular communication a cell may have a radius of up to 50 kilometers. It is further to be noted that for a radio access node, the larger the coverage region is, more power may be consumed for providing services to more terminal devices illustratively with higher transmit powers.

The radio access network 600 may include multiple cells 610a-d, each cell being associated a radio access node (e.g. RU) configured to provide a radio access service to multiple terminal devices (e.g. terminal devices 102, 104). Aspects associated with the radio access service provided by the respective radio access node may be represented in relation to the respective cell. In other words, the aspects provided in this disclosure with respect to a cell may also be represented as aspects with respect to the radio access node and/or the radio access service provided by the radio access node. It is to be noted that the radio access network 600 may include many cells associated with many radio access nodes.

A first cell 610a is depicted as it includes a first RU 601a serving first UEs 611a. A second RU 601b provides radio network services to second UEs 611b within a corresponding second cell 610b. A third RU 601c provides radio network services to third UEs 611c within a corresponding second cell 610c. A fourth RU 601d provides radio network services to fourth UEs 611d within a corresponding second cell 610d. As described in this disclosure, some UEs may be associated with multiple RUs as well which may be depending their association and geographical location.

The radio access network 600 may further include multiple DUs 630a-c. Each DU 630a-c may provide aspects described herein for a DU, including providing functions of a portion of the corresponding network stack, which the functions provided by DUs 630a-c are higher-layer functions in comparison with the functions provided by the RUs 601a-d of the portion of the corresponding network stack. Illustratively, the RUs 601a-d may provide RF and lower-PHY functions and the DUs 630a-c may provide higher PHY functions, MAC functions, and RLC functions.

In this constellation, each of the DUs 630a-c is configurable to provide the higher-layer functions of the corresponding network stack to any one of the RUs 601a-d. Illustratively, considering that all RUs 610a-d in the radio access network 600 are configured to provide radio access service to UEs 612a-d communicatively coupled to the RUs 610a-d (i.e. RUs 610a-d serving UEs 612a-d), each DU of the DUs 630a-c is configurable to provide processing of higher layers of the network stack to any one of UEs 612a-d for transmit/receive radio communication signals of the UEs 612a-d in uplink or downlink.

Accordingly, higher-level network stack services to be provided, traditionally by one DU, may be divided among multiple DUs 630a-c in accordance with lower-level network stack services of different RUs 610a-d and/or for different UEs 612a-d.

In accordance with various aspects described herein, the radio access network 600 may include a device 650, illustratively an intermediary node provided between multiple RUs 610a-d and multiple DUs 630a-c. The device 650 may communicate with multiple RUs 601a-d and multiple DUs 630a-c to provide data of respective data streams between a corresponding RU and a DU of a RU-DU pair, for all available RU-DU pairs.

The device 650 may accordingly route data associated with available data streams between a designated RU-DU pair including an RU of the RUs 610a-d and a DU of the DUs 630a-c, for multiple data streams between all designated RU-DU pairs to facilitate data routing, scalability, and flexibility associated to the radio access network 600 as illustrated in this disclosure.

Noting that existing disaggregated radio network architectures, such as O-RAN architecture, in which an O-RU, an O-DU, and an O-CU may work together for the complete network stack processing, the illustrated device 650 may be suitable to be implemented in many known disaggregated radio network architectures, including the O-RAN architecture.

In accordance with various aspects provided herein, the device 650 may include a programmable switch to manage data communication between the RUs 610a-d and the DUs 630a-c. The device 650 may, as a programmable switch, route and manage data traffic between the RUs 610a-d and the DU 630a-c, illustratively for uplink data sent from the RUs 610a-d to the DUs 630a-c, and for downlink data sent from the DUs 630a-c to the RUs 610a-d. With its programmable switch functions, the device 650 may allow defining and modifying RU-DU pairs to route data in-between. Illustratively, a programmable switch of present data center networks may have up to 24 or 48 ports of 100 Gbps, may operate with a 4-5 microseconds of switch latency. Illustratively, such a programmable switch may be reprogrammed throughput P4 or other methods. In other words, the device 650 may have an interface configurable via programming protocol-independent packet processors (P4) language to provide aspects described herein to change routing associated with RU-DU pairs, or provide aspects described herein.

It is to be noted that, traditionally, the connection relationship between an RU, a DU, and a CU may be considered as fixed through either physical fiber/cable connection or fixed switch link connection in-between. The configuration on the switch is static or semi-static on its routing configuration, and there is not in-line data processing on the switch. With the proposed device, a programmable, low-latency, high-throughput switch may be provided between the RUs 610a-d and the DUs 630a-c.

In some examples, as described herein, the device 650 may include a matrix operation function (e.g. implemented by a matrix multiplication processor, such as a general processor or a matrix multiplication accelerator), which can combine multiple data streams from multiple DUs 630a-c, and the device 650 may forward combined data streams to different RUs 610a-d based on a real-time controller for joint transmission. In some examples, the real-time controller may be configured to switch in real-time or in near-real-time (e.g. at subframe time interval level, 1 ms or less) based on UE information.

In accordance with various aspects described herein, the device 650 may enhance present disaggregated radio network architectures, such as O-RAN, in terms of providing a future cell-less, user-centric processing and natural support of joint receiving and transmitting operations. In some aspects, the scalability may further improve to support a large number of (e.g. more than a few hundreds) of cells or RUs 610a-d. In some aspects, power efficiency of the radio access network 600 may further improve due to employment of flexible resource allocation in accordance with dynamic user traffic within the radio access network 600. In some examples, the reliability of the radio access network 600 may also improve as any failure of a RU, a DU, or the fronthaul interface may be compensated by the device 650 with the distributed signal processing concept.

FIG. 7 shows an example of a device according to various examples in this disclosure. The device 700 may be the device 650 described in accordance with the aspects provided in FIG. 6 of a radio access network (e.g. the radio access network 600). In cellular communication context, the device 700 may include aspects of an intermediary node of a disaggregated radio communication architecture (e.g. Open-Radio Access Network (O-RAN)). In some aspects, device 700 may include a distributed unit (e.g. O-DU), a central unit (O-CU) or a RAN intelligent controller (e.g. a near-RT-RIC, a non-RT-RIC).

The device 700 may include a processor 701, a memory 702, and a communication interface 703 configured to receive and transmit communication signals in order to communicate with further entities within the radio access network. In some aspects, the communication interface 703 may include one or more signal paths to carry communication signals. The communication interface 703 may include one or more transceivers.

The processor 701 may include one or more processors, which may include a baseband processor and an application processor (e.g. application processor 212, baseband modem 206). In various examples, the processor 701 may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 701 may be implemented in one processing unit, e.g. a system on chip (SOC), or a processor. In accordance with various examples, the processor 701 may further provide further functions to process received communication signals. The memory 702 may store various types of information required for the processor 701, or the communication interface 703 to operate in accordance with various aspects of this disclosure.

The communication interface 703 may include a RU interface 703R configured to communicate with multiple RUs (e.g. the RUs 610a-d). For example, the RU interface 703R may include a corresponding port dedicated for each RU of the multiple RUs that receives and sends communication signals to the respective RU. The corresponding port may couple the device 700 to the corresponding RU of the multiple RUs via the corresponding fronthaul interface. Similarly, the communication interface 703 may include a DU interface 703D configured to communicate with multiple RUs (e.g. the DUs 630a-d). For example, the DU interface 703D may include a corresponding port dedicated for each DU of the multiple DUs that receives and sends communication signals to the respective DU. The corresponding port may couple the device 700 to the corresponding DU of the multiple DUs via the corresponding fronthaul interface.

The processor 701 may control the communication interface 703 according to designated network unit pairs including an RU of the multiple RUs and a DU of the multiple DUs. For one designated network unit pair including a first RU and a first DU, the processor 701 may control the communication interface 703 to route first UL data stream received from the first RU to the first DU in UL. In other words, in this configuration, the communication interface 703 may receive the first UL data stream from the first RU via the RU interface 703R, and send the first UL data stream to the first DU via the DU interface 703D. For DL, the processor 701 may control the communication interface 703 to route first DL data stream received from the first DU to the first RU. In other words, in this configuration, the communication interface 703 may receive the first DL data stream from the first DU via the DU interface 703D, and send the first DL data stream to the first RU via the RU interface 703R.

The processor 701 may perform the above-mentioned operation for each designated network unit pair. Illustratively, for a second designated network unit pair including a second RU and a second DU (noting that at least one of the second RU and/or the second DU is different from the first RU and/or the first DU respectively), the processor 701 may control the communication interface 703 to route second UL data stream received from the second RU to the second DU in UL. In other words, in this configuration, the communication interface 703 may receive the second UL data stream from the second RU via the RU interface 703R, and send the second UL data stream to the second DU via the DU interface 703D. For DL, the processor 701 may control the communication interface 703 to route second DL data stream received from the second DU to the second RU. In other words, in this configuration, the communication interface 703 may receive the second DL data stream from the second DU via the DU interface 703D, and send the second DL data stream to the second RU via the RU interface 703R.

In accordance with various aspects provided herein, the processor 701 may determine network unit pairs representing sender and receiver of data streams based on information received from an entity within the radio access network, for example from a CU providing network functions of the network stack higher than network functions provided by the DUs (e.g. an O-CU), or from the DUs. For example, the communication interface 703 may be configured to receive and decode and/or encode and transmit control information from such an entity. In some example, the entity may be an entity configured to determine UE associations, in particular UE-RU and/or UE-DU associations, some of which are described in this disclosure.

In accordance with various aspects provided herein, the processor 701 may determine the network unit pairs based on control information and/or multi-user scheduling information received from one of the multiple RUs and/or one of the multiple DUs. The control information may indicate an RU association and/or a DU association for a UE served by one of the RUs. In some examples, the processor 701 may determine the network unit pairs based on a routing algorithm according to a system objective, such as an objective associated with at least one of power consumption, network traffic performance, quality of services (QoS), coverage, cell load, etc.

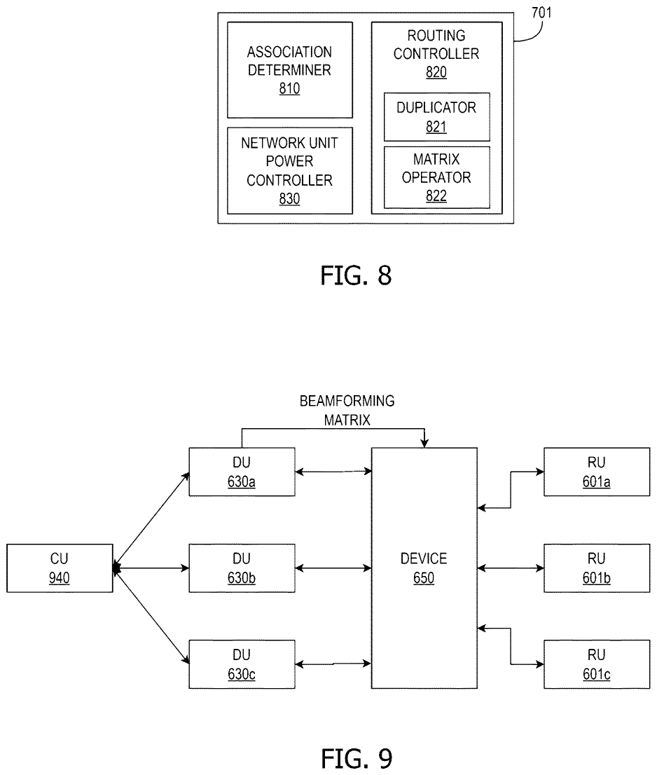

FIG. 8 shows an example of a schematically illustration of a processor in accordance with various aspects provided herein.. The processor 701 is depicted here to include various functional units that are configured to provide various functions as disclosed herein, associated with a processor (e.g. the processor 701) that may be used within a device (e.g. the device 650, the device 700). The skilled person would recognize that the depicted functional units are provided to explain various operations that the processor 701 may be configured to perform. The processor 701 may include an association determiner 810, a routing controller 820, and a network unit power controller 830. The routing controller 820 may include a data stream duplicator 821 and a matrix operation unit 822. As described above, an accelerator may implement the matrix operation unit 822.

The routing controller 820 may control the communication interface 703 according to designated network unit pairs as described in accordance with FIG. 7 to route UL data streams received from the RUs and DL data streams received from the DUs. Illustratively, for the configuration in which the communication interface 703 of the device 700 includes the RU interface 703R and the DU interface 703D, and each of these interfaces has dedicated ports for RUs and DUs, respectively, the routing controller 820 may cause the ports to establish connections between the device 700 and the corresponding RUs or DUs through fronthaul interfaces. Essentially, these interfaces may be deemed to act as the entry and exit points for data streams between the device 700 and the RUs/DUs.

The processor 701 may manage the communication interface 703 based on designated network unit pairs, i.e., specific pairings of RUs and DUs. For each designated pair, the processor 701 may configure the communication interface 703 to route UL and DL data streams between the corresponding RU and DU. For this purpose, the processor 701 may cause the communication interface 703 to set up communication paths between the RUs and DUs of each designated network pair. The communication interface 703, based on instructions received from the processor 701 may configure the ports and interfaces, to obtain communication paths for flow of data streams between designated network unit pairs by establishing links between the respective RU and DU interfaces of the designated network unit pairs.

Accordingly, the communication interface 703 may act as a data traffic controller, by receiving UL data stream from a RU of the multiple RUs from the RU interface 703R of the RU and forward the received UL data stream to a DU of the multiple DUs, which the DU is of the designated network pair including the RU, via the DU interface 703D of the DU. Similarly, the communication interface 703 may receive DL data stream from a DU of the multiple DUs from the DU interface 703D of the DU and forward the received DL data stream to a RU of the multiple RUs, which the RU is of the designated network pair including the DU, via the RU interface 703R of the RU.

Illustratively, in uplink, the device 650 may receive a first RU uplink stream from the first RU 601a, which the first RU uplink stream comprises communication signals of the first UEs 611a received by an antenna array of the first RU 601a. The device 650 may receive a second RU uplink stream from the second RU 601b, which the second RU uplink stream comprises communication signals of the second UEs 611b received by an antenna array of the second RU 601b. The device 650 may receive a third RU uplink stream from the third RU 601c, which the third RU uplink stream comprises communication signals of the third UEs 611c received by an antenna array of the third RU 601c. The device 650 may receive a fourth RU uplink stream from the fourth RU 601d, which the fourth RU uplink stream comprises communication signals of the fourth UEs 611d received by an antenna array of the fourth RU 601d.

The routing controller 820 may, based on designated network unit pairs, route received RU uplink streams, i.e. the first RU uplink stream, the second RU uplink stream, the third RU uplink stream, and the fourth RU uplink stream, for transmission to a first DU 630a, a second DU 630b, and a third DU 630c communicatively coupled to the device 650 via the communication interface 703, i.e. via the DU interface 703D. The routing controller 820 cause the DU interface 703D to send a first DU uplink stream to the first DU 630a, a second DU uplink stream to the second DU 630b, and a third DU uplink stream to the third DU 630c. Illustratively, the first DU uplink stream, the second DU uplink stream, and the third DU uplink stream may include the first RU uplink stream, the second RU uplink stream, the third RU uplink stream, and the fourth RU uplink stream.

For illustrative purposes, noting that previously designated network unit pairs including a first pair of the first RU 601a and the first DU 630a, a second pair of the second RU 601b and the first DU 630a, the first DU uplink stream may include the first RU uplink stream and the second RU uplink stream. A third pair of designated network unit pairs including a third pair of the third RU 601c and the second DU 630b, the second DU uplink stream may include the third RU uplink stream. A fourth pair including a pair of the third RU 601c and the third DU 630c, and a fifth par including a pair of the fourth RU 601d and the third DU 630c, and the third DU uplink stream may include the third RU uplink stream and the fourth RU uplink stream. Each corresponding DU may process received uplink stream to provide functions of respective layer of the network stack.

Illustratively, in downlink, the device 650 may receive a first DU downlink stream from the first DU 630a, which the first DU downlink stream. The device 650 may receive a second DU downlink stream from the second DU 630b. The device 650 may receive a third DU downlink stream from the third DU 630c.

In accordance with above-illustrated designated network unit pairs, the first DU stream may include a first RU downlink stream including communication signals to be transmitted by the first RU 601a to the first UEs 611a and a second RU downlink stream including communication signals to be transmitted by the second RU 601b to the second UEs 611b. The second DU downlink stream may include a third RU downlink stream including communication signals to be transmitted by the third RU 601c to the third UEs 611c. The third DU downlink stream may include a fourth RU downlink stream including communication signals to be transmitted by the third RU 601c to the third UEs 611c and a fifth RU downlink stream including communication signals to be transmitted by the fourth RU 601d to the fourth UEs 611d.

The routing controller 820 may, based on the designated network unit pairs, route received DU downlink streams, i.e. the first DU downlink stream, the second DU downlink stream, and the third DU downlink stream, for transmission to the first RU 601a, the second RU 601b, the third RU 601c, and the fourth RU 601d communicatively coupled to the device 650 via the communication interface 703, i.e. via the RU interface 703R. The routing controller 820 cause the RU interface 703R to send the first RU downlink stream to the first RU 601a, the second RU downlink stream to the second RU 601b, the third RU downlink stream to the third RU 601c, the fourth RU downlink stream to the third RU 601c, and the fifth RU downlink stream to the fourth RU 601d. Illustratively, the first RU downlink stream, the second RU downlink stream, the third RU downlink stream, the fourth RU downlink stream and the fifth RU downlink stream may include the first DU downlink stream, the second DU downlink stream, the third DU downlink stream.

In accordance with various aspects described herein, the radio access network 600 may be configured for joint transmission operations, in which multiple RUs may transmit radio communication signals collaboratively to one or more UEs. Instead of individual RUs operating independently, with the joint transmission, multiple RUs may combine their resources and transmit signals in a cooperative manner by performing transmissions to such one or more UEs configured for joint transmission, simultaneously, which may be provided by a synchronization scheme, in time domain, frequency domain, or spatial domain.

Through joint transmission operations, multiple RUs may jointly transmit radio communication signals to one or more UEs (e.g. UEs 425, 426 as illustrated in accordance with FIG. 4) to enhance the quality and reliability of the transmitted signals. In some examples, joint transmission operations may include spatial diversity and beamforming.

Accordingly, the routing controller 820 may include the matrix operation unit 822 configured to perform matrix operations to facilitate beamforming on downlink data streams and/or precoding on uplink data streams. In some examples, the matrix operation unit 822 may include a hardware accelerator configured to perform the matrix operations. The matrix operation unit 822 may perform predetermined in-line matrix operations for received uplink or downlink streams to obtain precoded uplink data streams or beamformed downlink data streams.

It is to be noted that an applied beamforming may involve causing RF signals to be transmitted by the RUs 601a-d to be adjusted in terms of phase and amplitude. Further, an applied precoding may optimizes received signals to enhance processing at the DUs 630a-c, considering the channel characteristics. By performing matrix operations, the matrix operation unit 822 may manipulate received data streams to achieve these goals before forwarding them to the target nodes (the RUs 601a-d or the DUs 630a-c).

Accordingly, through designated matrix operations, the matrix operation unit 822, may combine and process downlink data streams provided by the DUs 630a-c collectively before transmission to multiple target RUs of the RUs 601a-d. The matrix operations may further provide an interference cancellation or mitigation.

Accordingly, the routing controller 820 may cause the uplink DU streams to be transmitted to the DUs 630a-c to include precoded uplink data streams. Additionally, or alternatively, the routing controller 820 may cause the downlink RU streams to be transmitted to the RUs 601a-d to include beamformed downlink data streams.

FIG. 9 shows an illustrative example of a radio access network in accordance with various aspects described herein. In this illustrative example, the device 650 includes the matrix operation unit 822.

The processing of radio communication signals according to the network stack is disaggregated into a CU 940 (e.g. O-CU), multiple DUs 630a-c, and multiple RUs 601a-c, noting that only the first RU 601a, the second RU 601b, and the third RU 601c has been illustrated for brevity. Illustratively, the radio access network may be configured to operate to support joint transmission via joint MIMO transmissions to at least one or more UEs served by the radio access network (i.e. served by at least two RUs of the RUs 601a-d). Illustratively, such at least one or more UEs may be UEs 425, 426 illustrated in accordance with FIG. 4.

In this illustrative example, the first DU 630a may have obtained multi-user (MU) scheduling information. The MU scheduling information may indicate allocation of communication resources among multiple UEs served by the radio access network, illustratively including information representing downlink communication resources allocated for the at least one or more UEs. The communication resources may include time resources (e.g. symbols), frequency resources (e.g. subbands), and/or spatial resources (e.g. antenna beams) to transmit radio communication signals to the at least one or more UEs. In some examples, the first DU 630a may have further obtained downlink channel information representative of downlink channels of the at least one or more UEs.

Based on the MU scheduling information, and optionally based on the downlink channel information, the first DU 630a may determine a beamforming matrix to be applied to the respective downlink data streams carrying IQ data of the at least one or more UEs for the joint transmission, noting that different DUs of the DUs 630a-c may provide the processing of the network stack for such IQ data of the at least one or more UEs. The first DU 630a may send the determined beamforming matrix to the device 650. In some examples, the CU 940 may be the entity that determines the beamforming matrix as illustratively described herein.

Furthermore, the first DU 630a may encode information representing the communication resources suitable for joint transmission to the at least one or more UEs and send the encoded information to the device 650. The encoded information may further include UE allocation information indicative of the at least one or more UEs (i.e. UEs suitable for joint transmission). The processor 701 may decode the information to obtain information representing one or more time frames and the UE allocation information. The UE allocation information and the communication resources suitable for joint transmission may indicate to which IQ data within received downlink DU streams is the beamforming matrix to be applied.

Based on the UE allocation information, which may illustratively indicate designated network unit pairs for the at least one or more UEs, the processor 701 may cause the received beamforming matrix to be applied, by the matrix operation unit 822, to downlink data streams received from DUs of the designated network unit pairs for the at least one or more UEs, which are to be routed to RUs of the designated network unit pairs for the at least one or more UEs.

Illustratively, the at least one or more UEs are served by the first RU 601a and the second RU 601b, and each UE of the at least one or more UEs are associated with four designated network unit pairs, namely i) the first DU 630a and the first RU 601a, ii) the second DU 630b and the first RU 601a, iii) the first DU 630a and the second RU 601b, iv) the second DU 630b and the second RU 601b. Accordingly, the routing controller 820 may cause the matrix operation unit 822 to apply the received beamforming matrix to received first data of received first DU downlink stream from the first DU 630a and second data of received second DU downlink stream from the second DU 630b, to obtain beamformed first RU downlink streams and beamformed second RU downlink streams. The routing controller 820 then cause the beamformed first RU downlink streams to be sent to the first RU 601a and cause the beamformed second RU downlink streams to be sent to the second RU 601b.

It is to be noted that, in the downlink, support joint transmission with beamforming over the joint massive MIMO with the involvement of the matrix operation unit 822, (e.g. via an in-line matrix operation or on accelerator), the I/Q signal for multiple UEs including at least one or more UEs from multiple DUs 630a-c may be mixed (i.e. beamformed through matrix multiplication) before they are forwarded to one or more RUs 601a-c in the downlink. The received information indicating the communication resources may indicate a time frame in which the corresponding DUs are scheduled to send data to which the beamforming matrix is to be applied, which the device 650 may receive before data including corresponding IQ signals are received by the device 650. The matrix operation unit 822 may perform matrix operations (e.g. multiplication of beamforming matrix with the data), and the routing controller 820 may route these beamformed I/Q streams to target RUs indicated by corresponding network unit pairs of the at least one or more UEs. Accordingly, a distributed joint transmission scheme may be provided by the radio access network, in which each DU of the corresponding network unit pairs of the at least one or more UEs may perform processing of network stack of a subset of UEs served by one RUs of the corresponding network unit pairs, and there may not be a high bandwidth pressure for one particular DU.

In accordance with various aspects described herein, the radio access network 600 may be configured for joint reception operations, in which multiple RUs may receive radio communication signals collaboratively from multiple UEs. In particular, within the context of aspects described herein, in a joint reception operation, multiple DUs may be configured to process received uplink data of multiple UEs, received from one or more RUs, collaboratively. Accordingly, instead of a single DU processing received uplink data of the multiple UEs, multiple DUs may be allocated to process received uplink data of the multiple UEs.

Illustratively, for a received uplink data stream of the first RU 601a including first uplink data of first UEs and second uplink data of second UEs, the routing controller 820 may identify the first uplink data and the second uplink data. For example, the routing controller 820 may identify each uplink data of each UE of a plurality of UEs served by a RU within a received uplink data stream from the corresponding RU. Illustratively, an identified uplink data of a UE may include IQ data of the corresponding UE.

The first uplink data and/or the first UEs may be associated with a first network unit pair including the first RU 601a and the first DU 630a. The second uplink data and/or the second UEs may be associated with a second network pair including the first RU 601a and the second DU 630b. Illustratively, the first network unit pair and the second network pair described here may be based on MU scheduling decisions.

Noting that there is only one RU stream, the duplicator 821 may duplicate the received uplink data stream of the first RU 601a. The routing controller 820 may route the received uplink data stream of the first RU 601a and the duplicated uplink data stream to the first DU 630a and the second DU 630b. Illustratively, the routing controller 820 may route one of the received uplink data stream of the first RU 601a and the duplicated uplink data stream to the first DU 630a, and may route another one of the received uplink data stream of the first RU 601a and the duplicated uplink data stream to the second DU 630b.

In some examples, the duplicator 821 may duplicate only the corresponding uplink data identified from the received uplink data stream to be sent to the corresponding DU. Illustratively, the duplicator 821 may duplicate the second uplink data, and the routing controller 820 may route the duplicated second uplink data to be sent to the second DU 630b. Additionally, or alternatively, the duplicator may duplicate the first uplink data, and the routing controller 820 may route the duplicated first uplink data to be sent to the first DU 630a.

Through joint transmission operations, multiple RUs may jointly transmit radio communication signals to one or more UEs (e.g. UEs 425, 426 as illustrated in accordance with FIG. 4) to enhance the quality and reliability of the transmitted signals. In some examples, joint transmission operations may include spatial diversity and beamforming.

Traditionally, as disaggregated radio access network architectures are provided with a single baseband processing entity designated to provide network stack processing of higher layers configured to operate with multiple RUs, UE associations with the radio access network may be defined simply with RU associations. In accordance with various aspects described herein involving employment of multiple DUs providing network stack processing of higher layers, UE associations may involve both RU and DU associations, which may be described with the term network unit pair used in this disclosure, which may be directed to single UE of all UEs served by the radio access network.

In accordance with various aspects provided herein, the association determiner (AD) 810 may determine one or more network unit pairs for UEs served by the radio access network. Illustratively, a network unit pair designated for a UE may indicate which RU of the RUs 601a-d may provide RF and low-PHY services to that UE and which DU of the DUs 630a-c may provide high-PHY, MAC, and RLC services to that UE for network stack processing associated with communication of that UE with the radio access network. For example, based on the corresponding network unit pair designated for the corresponding UE, the routing controller 820 may route communication signals of the corresponding UE between the corresponding network unit pairs. For example, each UE of the UEs served by the radio access network may be associated with at least one network unit pair designated for the particular UE. Accordingly, the term network unit pairs for the UEs may illustratively include at least one network unit pair designated for each UE of the UEs served by the radio access network, or in some examples, at least one network unit pair designated for a subset of UE of the UEs, such that each UE is associated with at least one network unit pair.

Accordingly, the radio access network may provide support for user-centric processing, through which network resources and processing capabilities of the radio access network may be designated or optimized for individual users or user groups. In accordance with various aspects provided herein, the AD 810 may determine network unit pairs for the UEs based on various objectives designated for the UE association, such as an objective of data throughput, an objective of detection error minimization, an objective of fair QoS provision.

With this approach, aspects described for the AD 810 may result in schemes for allocation of network resources, such as bandwidth, processing power, or data transmission needs according to varying needs and demands of individual UEs to ensure that each UE receives an appropriate amount of service based on its respective requirements through tailored determination of network unit pairs.

Illustratively, the AD 810 may determine network unit pairs for the UEs based on a maximum data throughput objective, which may maximize the amount of data traffic within the radio access network. For example, the AD 810 may determine network unit pairs for the UEs which are estimated to maximize the amount of data communication within the radio access network. Similarly, the AD 810 may determine network unit pairs for the UEs based on a detection error minimization objective, which may minimize the detection errors.

In some examples, the AD 810 may determine network unit pairs for the UEs in accordance with QoS parameters designated for different UEs, which may illustratively allow prioritizing low latency, real-time, or near-real-time applications or providing high throughput for data-intensive UE communications. Illustratively, the AD 810 may determine network unit pairs for the UEs that maximizes estimated total QoS provided by the radio access network.

In some examples, the AD 810 may determine network unit pairs for the UEs based on at least one of UE behaviour, UE preferences, and/or historical network usage of individual UEs within the radio access network.

In some examples, the AD 810 may determine network unit pairs for the UEs based on a latency optimization objective associated with various network unit pairs to improve user experience. Illustratively, the AD 810 may determine network unit pairs for the UEs which are estimated to minimize the delay in data transmission and reception between UEs and the RUs 601a-d and/or between UEs and DUs 630a-c.

In some examples, the AD 810 may determine network unit pairs for the UEs based on a load balancing objective to prevent congestion and provide an efficient utilization of network resources. Illustratively, the AD 810 may determine network unit pairs for the UEs which are estimated to distribute network traffic efficiently among the RUs 601a-d and/or the DUs 630a-c.

In some examples, the AD 810 may determine network unit pairs for the UEs based on an energy efficiency objective to reduce total power consumption of the radio access network. Illustratively, the AD 810 may determine network unit pairs for the UEs, which are estimated to minimize power consumption through disabling one or more RUs and/or one or more DUs.

In some examples, the AD 810 may determine network unit pairs for the UEs based on a signal quality objective to reduce packet loss or interference. Illustratively, the AD 810 may determine network unit pairs for the UEs, which are estimated to minimize the packet loss and/or interference.

In some examples, the AD 810 may determine network unit pairs for the UEs based on a spectral efficiency objective. Illustratively, the AD 810 may determine network unit pairs for the UEs, which are estimated to maximize the spectral efficiency. Various further objectives may be illustrated as a mobility management objective for seamless connectivity during handovers, a resource allocation objective to optimize allocation of network resources, etc.

The AD 810 may determine network unit pairs for the UEs served by the radio access network through various methods in accordance with various objectives illustrated above. In some examples, the AD 810 may determine network unit pairs for the UEs using a trained artificial intelligence or machine learning model (AI/ML). It is to be noted that the AD 810 may determine the network unit pair s for the UEs based on various types of information, some of which may be provided by at least one of the RUs 601a-d, the DUs 630a-c, the CU 940, and/or even RICs associated with the radio access network. Accordingly, the device 650 may be configured to communicate with these entities via the communication interface 703 and the processor 701 may decode and/or encode messages carrying corresponding information, some of which are described herein.

It is further to be noted that although the AD 810 has been described as an entity of the device 650 together with the routing controller 820 and the power controller 830, this is illustrative and should not be limiting. There are various examples provided in this disclosure, in which the AD 810 is implemented by a processor of another entity within the radio access network. In such examples, the AD 810 may communicate with above-mentioned units of the radio access network through communication interfaces of corresponding entity including the AD 810.

The AD 810 may dynamically and/or determine network unit pairs for UEs, and accordingly change them from first network unit pairs for UEs to second network unit pairs for UEs. Illustratively, for a particular UE, the AD 810 may have determined a first network unit pair for the particular UE, in which the UE is associated with the first network unit pair. At an instance of time, the AD 810 may determine a second network unit pair for that particular UE, in which the association of the UE is changed from the first network unit pair to the second network unit pair. In particular, the first network unit pair and the second network unit pair may include at least one of different RUs or different DUs.

Illustratively, the first network unit pair may include the first RU 601a and the second DU 630b, and the second network unit pair may include the second RU 601b and the third DU 630c. At the time in which the first network unit pair is determined for the UE, the routing controller 820 may route uplink data of the UE received from the first RU 601a to the second DU 630 and may route downlink data of the UE received from the second DU 630 to the first RU 601a. At the time in which the second network unit pair is determined for the UE, the routing controller 820 may route uplink data of the UE received from the second RU 601b to the third DU 630c, and may route downlink data of the UE received from the third DU 630c to the second RU 601b. Illustratively, uplink data or downlink data of the UE may include IQ data (data representative of IQ signals) of the UE.

In accordance with various aspects described herein, the AD 810 may determine network unit pairs for the UEs by determining one or more RUs from the RUs 601a-d for the UEs (i.e. for each UE or each UE group). In some examples, the AD 810 may determine one or more RUs from the RUs 601a-d for the UEs based on control information received from the RUs 601a-d. For example, the control information received from each RU of the RUs 601a-d may indicate corresponding UEs determined to be served by the corresponding RU of the RUs 601a-d. In some examples, the AD 810 may determine one or more RUs from the RUs 601a-d for each UE based on a designated objective, some of which have been described above. Illustratively, RU associations (i.e. determining one or more RUs from the RUs 601a-d) of each UE may be determined as described below:

Noting that the maximum number of UEs that can be associated with an RU of the RUs 601a-d may be defined according to fronthaul limitations, each RU of the RUs 601a-d may serve a corresponding K number of UEs;

Let each UE associated with the radio access network to choose one RU of the RUs 601a-d, which may conventionally result in each UE choosing a corresponding RU of the RUs 601a-d with the largest signal-to-noise ratio (SNR);

UE choosing order may be randomized to increase the fairness of the operation;

If a RU has already be chosen by corresponding K number of UEs, let remaining UEs intended to choose that RU to choose another RU with the second largest SNR;

If each UE has chosen at least one RU, let each RU to choose further UEs until the number of UEs served by the corresponding RU reaches to the corresponding maximum UE number K.

It is to be noted that above-described operation is provided to illustrate the RU association of determining network unit pairs for each UE. It is to be noted that various commonly known methods may be applied herein to determine RU associations of the UEs, which may involve RUs choosing UEs having the lowest pathloss or highest SNR, noting that, eventually the geographic region served by the RUs are limited to provide appropriate radio communication performance to the UEs. In some examples, the AD 810 may select, for each UE, at least one RU from the RUs 601a-d for RU association according to any known methods.

In accordance with various aspects described herein, the AD 810 may determine network unit pairs for the UEs by determining one or more DUs from the DUs 630a-c for the UEs (i.e. for each UE or each UE group). In some examples, the AD 810 may determine one or more DUs from the DUs 630a-c for the UEs based on control information received from the RUs 601a-d and/or the DUs 630a-c. For example, the control information received from each RU of the RUs 601a-d or each DU of the DUs 630a-c may indicate corresponding UEs determined to be served by the corresponding DU of the DUs 630a-c. In some examples, the AD 810 may determine one or more DUs from the DUs 630a-c for each UE based on a designated objective, some of which have been described above. Illustratively, DU associations (i.e. determining one or more DUs from the DUs 630a-c) of each UE may be determined as described below:

Noting that the maximum number of RUs that can be associated with a DU of the DUs 630a-c may be defined, such that each DU of the DUs 630a-c may serve (i.e. provide network stack processing) to a corresponding N number of RUs.

The AD 810 may determine, for a particular UE, one DU of the DUs 630a-c. In that case, the routing controller 820 may route received uplink data of that UE, which may be received from one or more RUs of the RUs 601a-d, to that one DU. The AD 810 and the routing controller 820 may perform this for each UE within the radio access network. Further, the AD 810 may monitor designated network unit pairs to identify, for each DU of the DUs 630a-c, if the corresponding number of RUs served by a respective DU is equal or has exceeded the corresponding number N designated for the respective DU.

If the AD 810 determines that the corresponding number of RUs served by the respective DU is equal or has exceeded the corresponding number N, the AD 810 may select N number of best performing RUs based on a communication performance metric, such as channel conditions, largest channel gain, data throughput, etc. to maintain associations of those selected N number of best performing RUs. Further for remaining non-selected RUs, the AD 810 may change designated network unit pairs including the respective DU and non-selected RUs by assigning one or more DUs that are different from the respective DU.

For this purpose, the AD 810 may process determined network unit pairs of all UEs, noting that each UE may be associated with one or more network unit pairs, by sorting UEs with the number of associated RUs in a descend order. Illustratively, for a given UE being associated with a first network unit pair including the first DU 630a and the first RU 601a, a second network unit pair including the first DU 630a and the second RU 601b, a third network unit pair including the first DU 630a and the third RU 601c, and a fourth network unit pair including the second DU 630b and the third RU 601c, the number of associated RUs may be 3.

The AD 810 may perform an iterative algorithm starting from selecting the UE having the greatest number of associated RUs iterating towards the UE having the least number of associated RUs. With each further iteration, the AD 810 may select a UE in the descend order. The AD 810 may select a DU for a selected UE, and for each selected UE associated with a set of RUs including one or more RUs of the RUs 601a-d (e.g. illustratively associated in accordance with above-mentioned RU association), the AD 810 may select that DU for other UEs served by the set of RUs associated with the selected UE. The AD 810 may perform the iterative algorithm until all UEs served by all of the RUs 601a-d are associated with at least one DU.

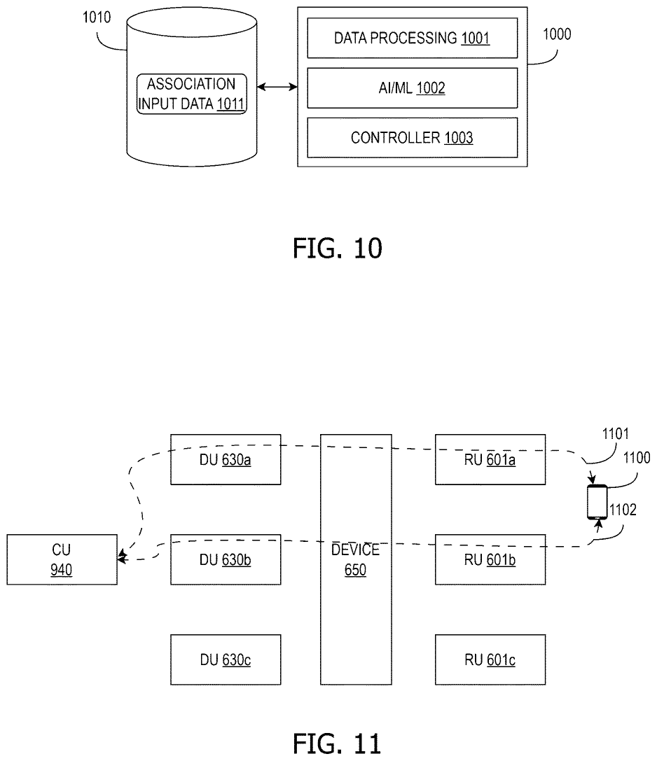

In some examples, the AD 810 may implement the trained AI/ML to determine the network unit pairs for each UE served by the radio access network. FIG. 10 shows schematically an example of a processor and a memory to implement an AI/ML. The AD 810 may include the processor 1000. The processor 1000 is depicted to include various functional units that are configured to provide various functions as disclosed herein, associated with the processor 501. The skilled person would recognize that the depicted functional units are provided to explain various operations that the processor 1000 may be configured to perform. Similarly, the memory 1010 (e.g. the memory 502) is depicted to include the association input data 1011 as a block, however, the memory 1010 may store the association input data 1011 in any kind of suitable configuration or mechanism.

Illustratively, the association input data 1011 may include RAN-related data which may include any type of information that is representative of the operation of the radio access network service provided by the network access node of the cell. The RAN-related data may include information representative of the performance or the resource utilization of the radio access network. In some examples, the RAN-related data may be associated with a cell served by an RU of the RUs 601a-d. In some aspects, RAN-related data of a cell may include RAN telemetry data that may encompass at least one of various performance metrics (radio communication, device computation, energy consumption, etc.), user equipment (UE) data for which the UEs are served by the network access node of the cell, channel quality indicators associated with radio communication channels with the UEs, traffic data within the cell (i.e. data communicated (received or transmitted) by the respective network access node, mobility data, and spectrum usage information. In some aspects, RAN-related data of a cell may include RAN monitoring data that may encompass data gathered from observing and measuring different aspects of the RAN, such as at least one of the radio network performance within the cell, behavior of the UEs served by the respective network access node (UE behavior), patterns of network traffic within the cell, and cell-specific parameters of the cell. In some additional aspect, RAN-related data may include RAN operational data of the cell, which is related to the functioning and performance of the RAN, which the RAN-operational data may encompass at least one of radio access network metrics, UE information of the UEs served by the respective network access node, channel quality indicators (CQIs) of the UEs, traffic and mobility data, spectrum usage, and cell-specific factors. Each example provided herein may be referred to as an attribute of RAN-related data. RAN-related data may also be referred to as RAN data.

Additionally, or alternatively, the association input data 1011 may include cell-specific parameters of the cells served by the RUs 601a-d, which may include any type of information representative of an attribute or a feature associated with the cell, which the attribute or feature influences the performance of the behavior of the cell. Cell-specific parameters may include information representative of at least one of: geolocation including the physical location of the cell, which may include its latitude, longitude, and altitude, which can impact radio signal propagation and coverage; topography of the cell including the terrain surrounding the cell, such as hills, valleys, or flatlands, which can affect radio signal propagation and potential interference; an Urban or a rural setting which may indicate the population density and types of structures (residential, commercial, or industrial) surrounding the cell, which can influence radio signal propagation, interference, and user demand; building materials and obstacles which may include the presence of buildings or other physical barriers, and the materials they are made of, which can attenuate radio signals and create multipath propagation effects; infrastructure including the availability and quality of power, backhaul, and other supporting infrastructure, which can impact the overall performance of the cell; spectrum allocation and usage which may include the frequency bands allocated to the cell, and their current usage, which can affect the capacity and interference levels within the cell, such as UE distribution, a number of UEs in an RRC connected state, a number of active UEs, reference signal strength indicator (RSSI) associated with the UEs, reference signal receive power (RSRP) associated with the UEs, CQI summaries of the UEs; UE distribution that may include the spatial distribution and density of user devices within the cell, which can impact resource allocation, signal strength, and user experience; traffic patterns which may include the types and volumes of data traffic within the cell, such as voice, video, and data applications, which can impact network congestion and resource allocation, such as downlink traffic, uplink traffic, physical resource block (PRB) usage, data throughput; and/or mobility patterns that may indicate the movement of users within the cell, including the frequency of handovers, cell reselections, and other mobility events, which can influence network stability and performance. Each example provided herein may be referred to as an attribute of cell-specific parameters.

Additionally, or alternatively, the association input data 1011 may include UE information of all UEs served by the radio access network. Illustratively, the UE information may include information representing at least one of radio channel conditions of UEs, signal strength indicators such as received signal strength indicators (RSSI), reference signal power indicators such as reference signal received power (RSRP), path loss parameters, timing parameters associated with timing advance, location of the UE, position information a velocity of the UE, a heading of UE, and/or a trajectory of the UE, UE capability information, etc.

Furthermore, the AI/ML unit 1002 is depicted as it is implemented in the processor 1000 only as an example, and any type of AI/ML implementation which may include the implementation of the AI/ML in an external processor, such as an accelerator, a graphics processing unit (GPU), a neuromorphic chip, or in a cloud computing device, or in an external processing device may also be possible according to any methods.

The processor 1000 may include a data processing unit 1001 that is configured to process data and obtain input data for the AI/ML unit based on the association input data 1011 as provided in various examples in this disclosure to be stored in the memory 1010. In various examples, the association input data 1011 may include not only current but also past information for at least within a period of time in a plurality of instances of time (e.g. as a time-series data).

The data processing unit 1001 may implement various preprocessing operations to obtain the association input data 1011. Such operations may include cleaning the telemetry data by removing outliers, handling of missing parameters, correcting errors or inconsistencies, and such. Operations may further include data normalizations in order to scale the association input data 1011 to a common range. Operations may further include data transformation including mapping the association input data 1011 based on predefined mapping operations corresponding to mathematical functions to map one or more data items of the association input data 1011 to a mapped data time for the purpose of analysis.

The data processing unit 1001 may be configured to generate training dataset based on the association input data 1011. In other words, based output of the AI/ML unit 1002 in response to the input data, the data processing unit 1001 may prepare the training data to be used in the training of the AI/ML The data processing unit 1001 may be configured to apply data fusion techniques to aggregate data. Data fusion may be considered as a process of integrating and combining data, within this context, by combining the association input data 1011 to obtain a unified dataset.

The data processing unit 1001 may further implement feature extraction operations. It is to be considered that the AI/ML implemented by the AI/ML unit may have certain constraints, some of which may relate to the structure and aspects of the data to be inputted to the AI/ML. The feature extraction operations may include translating (i.e. transforming) the association input data 1011 into input data of the AI/ML. The feature extraction operations may further include generation of training input data for the training dataset based on the association input data 1011. In some aspects, the feature extraction operations may be based on model information representing the attributes to be used as the input of the AI/ML, relative importance or weights of the attributes, etc. The feature extraction operations may include reducing the number of attributes (i.e. data items from the association input data 1011) to be used, ranking of the attributes, etc. based on the model information.

Illustratively, the trained AI/ML as described herein may be configured to receive the input data of the AI/ML that is based on the association input data 1011 and process the input data to map the received input data according to present AI/ML parameters to output data including one or more network unit pairs, each network unit pair including one DU selected from predefined DUs (e.g. the DUs 630a-c) and one RU selected from predefined RUs (e.g. the RUs 601a-d). The AI/ML parameters have been determined through a training process, some of which have been described herein, associated to designated objectives as described in this disclosure.

In some aspects, the association input data 1011 may include information representative of annotations and/or labels to be used for training according to one of the designated objectives in this disclosure. In some aspects, the data processing unit 1001 may also assign labels or assign ground truth values for the generated training data for the generation of the training dataset. In some aspects, the data processing unit 1001 may further generate annotations for the generation of the training data set. Generation of annotations and/or labels may be according to supervised training inputs, or may be based on unsupervised methods, exemplarily by an implementation of an automatized model to assign the labels and/or the annotations.

For supervised learning, generation of labels and annotations may require domain expertise and an understanding of the specific tasks that the AI/ML is designed to address. For example, a human expert might need to review network logs and performance data to identify contributions to communication resource efficiency, which could then be labeled as positive or negative examples for a congestion prediction model. In some cases, semi-supervised or unsupervised learning techniques can be used to reduce the reliance on labeled data. These approaches may involve clustering, anomaly detection, or other methods that can identify patterns and relationships in the data without explicit ground truth labels.

Accordingly, the data processing unit 1001 may generate the training dataset based on the association input data 1011. It is to be noted that the AI/ML unit 1002 may use the training dataset in predefined portions, namely a first portion of the training data set for training, a second portion of the training dataset for validation and a third portion of the training dataset for testing purposes. The AI/ML unit 1002 may use the first portion to train the AI/ML, which may allow the AI/ML to learn the underlying patterns and relationships in the data one of the designated objectives in this disclosure. The AI/ML unit 1002 may use the second portion to evaluate and fine-tune the AI/ML during the training process, which may help to prevent overfitting and improve generalization. Finally, the AI/ML unit 1002 may use the third portion to assess the performance of the trained AI/ML and provide an unbiased estimate of their accuracy and effectiveness for AI/ML tasks.

The AI/ML unit 1002 may implement one or more AI/MLs. The aspects are provided for one AI/ML but it may also include applications involving more than one AI/MLs. The AI/ML may be configured to receive input data with certain constraints, features, and formats. Accordingly, the data processing unit 1001 may obtain input data, that is based on the association input data 1011, to be provided to the AI/ML to obtain an output of the AI/ML. In various examples, the data processing unit 1001 may provide input data including the association input data 1011 to the AI/ML. The input data may include attributes of the association input data 1011 associated with a period of time or a plurality of consecutive periods of time. In various examples, the data processing unit 1001 may convert the association input data 1011 to an input format suitable for the AI/ML (i.e. feature extraction e.g. to input feature vectors) so that the AI/ML may process the association input data 1011.

The processor 1000 may further include a controller 1003 to control the AI/ML unit 1002. The controller 1003 may provide the input data to the AI/ML, or provide the AI/ML unit 1002 instructions to obtain the output. The controller 1003 may further be configured to perform further operations of the AD 810 in accordance with various aspects of this disclosure.

The AI/ML may be any type of machine learning model configured to receive the input data and provide an output as provided in this disclosure. The AI/ML may stand for the ML-based application provided in the disclosure. The AI/ML may include any type of machine learning model suitable for the purpose. The AI/ML may include a decision tree model or a rule-based model suitable for various aspects provided herein. The AI/ML may include a neural network. The neural network may be any type of artificial neural network. The neural network may include any number of layers, including an input layer to receive the input data, an output layer to provide the output data. A number of layers may be provided between the input layer and the output layer (e.g. hidden layers). The training of the neural network (e.g., adapting the layers of the neural network, adjusting AI/ML parameters) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain AI/ML (e.g. weights) parameters adjusting the input information.

The AI/ML may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input data, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the neural network may be configured in top-down configuration in which a neuron of a layer provides output to a neuron of a lower layer, which may help to discriminate certain features of an input.

In accordance with various aspects, the AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input data for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The AI/ML may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input data in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to AI/ML parameters of the generation function and the input data, the discrimination function may distinguish the data generated by the generation function in terms of data distribution according to AI/ML parameters of the discrimination function. In accordance with various aspects of this disclosure, a GAN may include a deconvolutional neural network for the generation function and a CNN for the discrimination function. The AI/ML may include a trained AI/ML that is configured to provide the output as provided in various examples in this disclosure based on the input data and one or more AI/ML parameters obtained by the training. The trained AI/ML may be obtained via an online and/or offline training. A training agent may perform various operations with respect to the training at various aspects, including online training, offline training, and optimizations based on the inference results. The AI/ML may take any suitable form or utilize any suitable technique for training process. For example, the AI/ML may be trained using supervised learning, semi-supervised learning, unsupervised learning, or reinforcement learning techniques.

In supervised learning, the AI/ML may be obtained using a training dataset including both inputs and corresponding desired outputs (illustratively, input data may be associated with a desired or expected output for that input data) obtained according to one of the designated objectives in this disclosure. Each training instance may include one or more input data item and a desired output. The training agent may train the AI/ML based on iterations through training instances and using an objective function according to one of the designated objectives in this disclosure to teach the AI/ML to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data according to one of the designated objectives in this disclosure. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the AI/ML parameters of the respective model based on outputs and inputs (i.e. output data and input data). The training agent may train the AI/ML according to the desired outcome. The training agent may provide the training data to the AI/ML to train the AI/ML. In various examples, the processor and/or the AI/ML unit itself may include the training agent, or another entity that may be communicatively coupled to the processor may include the training agent and provide the training data to the device, so that the processor may train the AI/ML.

In various examples, the device may include the AI/ML in a configuration that it is already trained (e.g. the AI/ML parameters in a memory are already set for the purpose). It may be desirable for the AI/ML itself to have the training agent, or a portion of the training agent, in order to perform optimizations according to the output of inferences as provided in this disclosure. The AI/ML may include an execution unit and a training unit that may implement the training agent as provided in this disclosure for other examples. In accordance with various examples, the training agent may train the AI/ML based on a simulated environment that is controlled by the training agent according to similar considerations and constraints of the deployment environment.

The processor 1000 may implement the training agent, or another entity that may be communicatively coupled to the processor 1000 may include the training agent and provide the training input data to the device, so that the processor 1000 may train the AI/ML. The training agent may be part of the AI/ML unit 1002 described herein. Furthermore, the controller 1003 may control the AI/ML unit 1002 according to a predefined event. For example, the controller 1003 may provide instructions to the AI/ML unit 1002 to perform the inference and/or training in response to a received request from another entity. The controller 1003 may further obtain output of the AI/ML from the AI/ML unit 1002.

FIG. 11 show an example of an illustration of processing of communication data for a UE in a disaggregated radio access network as described in accordance with FIG. 9. In this illustrative example, the AD 810 may determine a first network unit pair including the first RU 601a and the first DU 630a. As illustrated with a first processing path 1101, according to the first network unit pair of the UE 1100, the first RU 601a may receive uplink RF signals and provide uplink data of the UE 1100 to the device 650. The device 650 may route the uplink data to the first DU 630a according to the determined first network unit pair. The first DU 630a may perform processing of the network stack designated for the DUs 630a-c (e.g. high-PHY, MAC, RLC) and provide the processed uplink data to the CU 940 for further processing of the network stack. For downlink, the CU 940 may provide downlink data for the UE 1100 to the first DU 630a, which performs processing of the network stack designated for the DUs 630a-c and provide the processed downlink data to device 650. The device 650 may route the processed downlink data received from the first DU 630a to the first RU 601a which transmit RF signals carrying the processed downlink data to the UE 1100.

Illustratively, at one stage, the AD 810 may determine a second network unit pair for the UE and instruct the UE and/or the first RU 601a for a handover to the second RU 601b. Accordingly, at a further instance of time, as illustrated with a second processing path 1101, according to the second network unit pair of the UE 1100, the second RU 601b may receive uplink RF signals and provide uplink data of the UE 1100 to the device 650. The device 650 may route the uplink data to the second DU 630b according to the determined second network unit pair. The second DU 630b may perform processing of the network stack designated for the DUs 630a-c (e.g. high-PHY, MAC, RLC) and provide the processed uplink data to the CU 940 for further processing of the network stack. For downlink, the CU 940 may provide downlink data for the UE 1100 to the second DU 630b, which performs processing of the network stack designated for the DUs 630a-c and provide the processed downlink data to the device 650. The device 650 may route the processed downlink data received from the second DU 630b to the second RU 601b which transmit RF signals carrying the processed downlink data to the UE 1100.

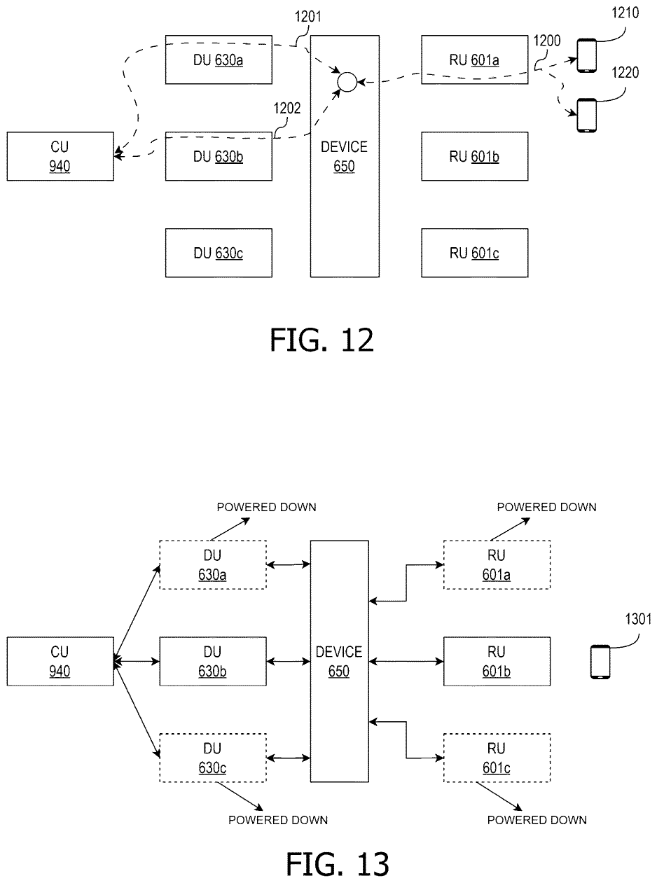

FIG. 12 show an example of an illustration of processing of communication data for a UE in a disaggregated radio access network as described in accordance with FIGS. 9 and 11. In this illustrative example, the AD 810 may determine a first network unit pair including the first RU 601a and the first DU 630a for a first UE 1210 and the AD 810 may determine a second network unit pair including the first RU 601a and the second DU 630b for a second UE 1220. As illustrated with a common processing path 1200, the first RU 601a may receive uplink RF signals of the first UE 1210 and uplink signals of the second UE 1220 and provide uplink data of the first UE 1210 and the uplink data of the second UE 1220 to the device 650 according to the first network unit pair of the first UE 1210 and the second network unit pair of the second UE. As illustrated with a first processing path 1201, the device 650 may route the uplink data of the first UE 1210 to the first DU 630a according to the first network unit pair. The first DU 630a may perform processing of the network stack designated for the DUs 630a-c (e.g. high-PHY, MAC, RLC) and provide the processed uplink data of the first UE 1210 to the CU 940 for further processing of the network stack. As illustrated with a second processing path 1202, the device 650 may further route the uplink data of the second UE 1220 to the second DU 630b according to the second network unit pair. The second DU 630b may perform processing of the network stack designated for the DUs 630a-c (e.g. high-PHY, MAC, RLC) and provide the processed uplink data of the second UE 1220 to the CU 940 for further processing of the network stack.

For downlink, as illustrated with the first processing path 1201, the CU 940 may provide downlink data of the first UE 1210 to the first DU 630a, which performs processing of the network stack designated for the DUs 630a-c and provide the processed downlink data of the first UE 1210 to the device 650. Further, as illustrated with the second processing path 1202, the CU 940 may provide downlink data of the second UE 1220 to the second DU 630b, which performs processing of the network stack designated for the DUs 630a-c and provide the processed downlink data of the second UE 1220 to the device 650. The device 650 may route the received processed downlink data of the first UE 1210 from the first DU 630a and received processed downlink data of the second UE 1220 from the second DU 630b to the first RU 601a which transmit RF signals carrying downlink data of the first UE 1210 and the second UE 1220.

In accordance with various aspects described herein, the AD 810 may further determine network unit pairs indicating RU and DU associations of the radio access network for the UEs served by according to a power conservation objective and/or monitor determined network unit pairs to identify a power saving network unit which may include at least one RU of the RUs 601a-d and/or one DU of the DUs 630a-c in order to scale up or scale down the radio access network. The AD 810 may accordingly instruct the network unit power controller 830 to cause the corresponding power saving network unit to operate in a low power mode or in a turned off mode to scale down the network and/or instruct the network unit power controller 830 to cause the corresponding power saving network unit to operate in a normal mode in which the corresponding power saving network unit provides its service associated with the processing of the network stack.

Illustratively, through this power saving operation, the AD 810 may determine network unit pairs for the UEs being served by the radio access network, such that designated coverage to serve all the UEs at designated service level agreements are maintained without interruption of the network service, and dynamically provide information to the network unit power controller 830 to selectively activate or deactivate the RUs 601a-d or the DUs 630a-b.

FIG. 13 show an example of an illustration of processing of communication data for a UE in a disaggregated radio access network as described in accordance with FIGS. 9, 11, and 12. In this illustrative example, the AD 810 may determine each the first RU 601a, the third RU 601c, the first DU 630a, and the third DU 630c as power saving network units and provide information to the network unit power controller 830 indicating the determined power saving network units. Accordingly, the network unit power controller 830 may communicate each of these power saving network units to cause each of them to operate in a low power mode or power down corresponding operations performed by these DUs and RUs.

Illustratively, this may indicate a scenario in which the AD 810 may have determined network unit pairs of the UEs served by the radio access network accordingly. For example, the AD 810 may have determined network unit pairs of some UEs previously served by the first RU 601a and the third RU 603c new network unit pairs to associate them to new RUs and new DUs of available RUs and DUs, illustratively with the second RU 601b and the second DU 630b in this example.

Furthermore, as the load of the radio access network in terms of served UEs increase or as the AD 810 identifies UEs which may only be served by any one of the powered down network units, the AD 810 may provide information to the network unit power controller 830 indicating those power saving network units are to be operated in a normal mode in which the corresponding network unit may provide service. Accordingly, the network unit power controller 830 may communicate with entities implementing corresponding network unit to become operational.

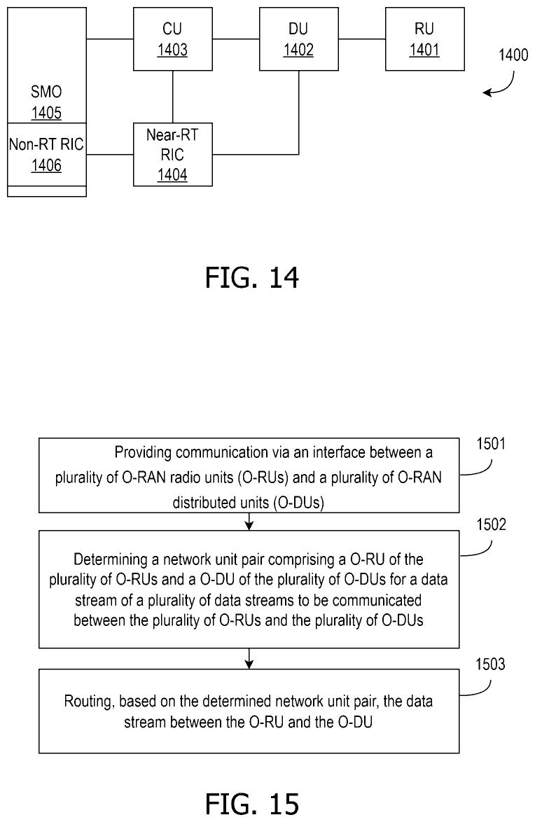

FIG. 14 shows an exemplary radio access network architecture in which the radio access network is disaggregated into multiple units. In LTE or 5G NR, network access nodes, such as a BS may implement the whole network stack including physical layer (PHY), media access control (MAC), radio link control (RLC), packet data convergence control (PDCP), and radio resource control (RRC) functions of the network stack. In a distributed approach of radio access networks, the processing of the network stack is disaggregated into at least two units (e.g. into RU, DU, and CU). Although the example illustrates a distributed structure that is based on open-RAN (O-RAN) architecture, the skilled person is able to populate the teaching provided herein in other types of distributed architectures, such as baseband unit (BBU) that may operate in the cloud and may be split to a Control Unit (CU) according to Rel.15 of 3GPP standards.

In various deployments in recently emerged RAN architectures, such as Open Radio Access Network (O-RAN) architectures, network access nodes may have functionalities that are split among multiple units with an intention to meet the demands of increased capacity requirements by providing a flexible and interoperable approach for RANs. The exemplary RAN 1400 provided herein includes a radio unit (RU) 1401, a DU 1402, a CU 1403, a near RT-RIC 1404, and a service management and orchestration framework (SMO) 1405 including a non-RT RIC 1406. The skilled person would recognize that the illustrated structure may represent a logical architecture, in which one or more of the entities of the mobile communication network may be implemented by the same physical entity, or a distributed physical entity (a plurality of devices operating collectively) may implement one of the entities of the mobile communication network provided herein.

There are many approaches to provide the split among the multiple units. In this illustrative example, the CU 1403 (e.g. O-CU) may be mainly responsible for non-real time operations hosting the radio resource control (RRC), the PDCP protocol, and the service data adaptation protocol (SDAP). The DU (e.g. O-DU) 1402 may be mainly responsible for real-time operations hosting, for example, RLC layer functions, MAC layer functions, and Higher-PHY functions. RUs 1401 (e.g. O-RU) may be mainly responsible for hosting the Lower-PHY functions to transmit and receive radio communication signals to/from terminal devices (e.g. UEs) and provide data streams to the DU over a fronthaul interface (e.g. open fronthaul). The SMO 1405 may provide functions to manage domains such as RAN management, Core management, Transport management, and the non-RT RIC 1406 may provide functions to support intelligent RAN optimization via policy-based guidance, AI/ML model management, etc. The near-RT RIC 1404 may provide functions for real time optimizations, including hosting one or more xApps that may collect real-time information (per UE or per Cell) and provide services, that may include AI/ML services as well.

The exemplary RAN 1400 is illustrated for the purpose of brevity. The skilled person would recognize the aspects provided herein and may also realize that the exemplary RAN 1400 may include further characterizations, such as the CU may also be-at least logically-distributed into two entities (e.g. CU-Control Plane, CU-User Plane), there may be various types of interfaces between different entities of the exemplary RAN 1400 (e.g. E2, F1, O1, X2, NG-u, etc.).

In accordance with the exemplary distributed RAN architecture, a UE may transmit radio communication signals to the RU 1401 and receive radio communication signals from the RU 1401. The processing associated with the communication is performed at the respective layers of the network stack by respective entities that are responsible to perform the corresponding function of the respective layers.

In accordance with various aspects of this disclosure the device 650 may be provided between multiple RUs 1401 and multiple DUs 1402. In accordance with various aspects described herein the device 650 may include the AD 810 as described herein, which illustrated as part of the device 650 as an example. In various examples, other entities of the exemplary RAN 1400 may include the AD 810 as described herein, which may be referred to as an external AD 810. The external AD 810 may communicate with the device 650 over a designated separate interface or present interfaces linking the entity including the external AD 810 to the device 650 or to an entity communicatively coupled to the device 650 such as the RU 1401 or the DU 1402.

In some examples, one or all of the multiple DUs 1402 may include the external AD 810. In this approach, the external AD 810 may collect information needed to determine network unit pairs from the RUs 1401, other DUs not including the particular external AD 810, the CU 1403, and the RICs 1404, 1406.

In some examples, the CU 140 may include the external AD 810. In this approach, the external AD 810 may collect information needed to determine network unit pairs from the RUs 1401, the DUs 1402, the CU 1403, and the RICs 1404, 1406.

In some examples, one of the RICs 1404, 1406 may include the external AD 810. In this approach, the external AD 810 may collect information needed to determine network unit pairs from the RUs 1401, the DUs 1402, the CU 1403, and the RICs 1404, 1406. In some examples, another entity may include the external AD 810.

In all of these examples including the external AD 810, the external AD 810 may communicate with the device 650 to provide information representing the determined network unit pairs of the RAN 1400. Illustratively, the external AD 810 may encode information to provide described indications to the routing controller 820 or the network unit power controller 830 of the device 650.

FIG. 15 shows an example of a method. The method may include providing 1501 communication via an interface between a plurality of O-RAN radio units (O-RUs) and a plurality of O-RAN distributed units (O-DUs); determining 1502 a network unit pair comprising a O-RU of the plurality of O-RUs and a O-DU of the plurality of O-DUs for a data stream of a plurality of data streams to be communicated between the plurality of O-RUs and the plurality of O-DUs; routing 1503, based on the determined network unit pair, the data stream between the O-RUs and the O-DU. A non-transitory computer-readable medium may include instructions which, if executed by a processor, cause the processor to perform the method.

The following examples pertain to further aspects of this disclosure.

In example 1, the subject matter includes an apparatus of an intermediate node of an open radio access network (O-RAN), the apparatus including: an interface configured to provide communication between a plurality of O-RAN radio units (O-RUs) and a plurality of O-RAN distributed units (O-DUs); a processor configured to: determine a network unit pair including a O-RU of the plurality of O-RUs and a O-DU of the plurality of O-DUs for a data stream of a plurality of data streams to be communicated between the plurality of O-RUs and the plurality of O-DUs; route, based on the determined network unit pair, the data stream between the O-RUs and the O-DU.

In example 2, the subject matter of example 1, where the processor is configured to duplicate an uplink data stream for a transmission to multiple O-DUs of the plurality of O-DUs, wherein the uplink data stream is received from an O-RU of the plurality of O-RUs.

In example 3, the subject matter of example 2, wherein the uplink data stream is addressed to a first O-DU, and the multiple O-DUs includes the first O-DU and at least one second O-DU.

In example 4, the subject matter of example 2 or example 3, wherein the processor is configured to determine the uplink data stream to be duplicated from a plurality of uplink data streams based on a multi user scheduling information.

In example 5, the subject matter of any one of examples 2 to 4, wherein the processor is configured to duplicate the uplink data stream based on control information received from at least one of the plurality of O-RUs and/or the plurality of O-DUs.

In example 6, the subject matter of any one of examples 1 to 5, wherein the processor is further configured to change a first routing of a previously routed data stream between a first network unit pair including one of the plurality of O-RUs and one of the plurality of O-DUs to a second routing between a second network unit pair.

In example 7, the subject matter of example 6, wherein the processor is configured to change an association of a user equipment (UE) from the first network unit pair to the second network unit pair.

In example 8, the subject matter of example 6 or example 7, wherein the first network unit pair and the second network unit pair include different O-DUs of the plurality of O-DUs.

In example 9, the subject matter of any one of examples 1 to 8, wherein the processor is configured to determine a data stream path of a UE based on a O-RU association of the UE; wherein the O-RU association of the UE is determined based on a throughput maximization or a detection error minimization objective.

In example 10, the subject matter of example 9; wherein the O-RU association of the UE is determined jointly across the plurality of O-RUs.

In example 11, the subject matter of example 9 or example 10, wherein the processor is further configured to determine the O-RU association of the UE by selecting a best estimated O-RU from available O-RUs of the plurality of O-RUs.

In example 12, the subject matter of any one of examples 1 to 11, wherein the network unit pair is determined based on a routing algorithm according to a designated system objective.

In example 13, the subject matter of example 12, wherein the network unit pair is determined based on a maximum number N of RUs of the plurality of O-RUs that are to be associated with the plurality of O-DUs; wherein if the maximum number of O-RUs have been associated with the plurality of O-DUs is exceeded, best performing N O-RUs are selected.

In example 14, the subject matter of example 12 or example 13, wherein O-DU associations for a plurality of UEs served by the plurality of O-RUs are determined iteratively starting from a UE of the plurality of UEs associated with the most O-RUs of the plurality of O-RUs.

In example 15, the subject matter of any one of examples 1 to 14, wherein the processor is configured to determine a power saving unit selectively from at least one of the plurality of O-RUs or the plurality of O-DUs to change an operation mode of the unit.

In example 16, the subject matter of example 15, wherein the processor is configured to encode a message for a transmission to the power saving unit, wherein the message includes an indication for the power saving unit to operate in a low power mode or to wake up from the low power mode.

In example 17, the subject matter of example 15 or example 16, wherein the processor is configured to route data streams of a network unit pair including the power saving unit to another network unit pair.

In example 18, the subject matter of any one of examples 15 to 17, wherein the processor is configured to determine the power saving unit based on a received control information representing an identifier of the power saving unit.

In example 19, the subject matter of any one of examples 15 to 18, wherein the processor is configured to determine the power saving unit based on network traffic information representative of an amount of the network traffic associated with the power saving unit and a threshold.

In example 20, the subject matter of example 19, wherein the processor is configured to monitor the data streams to determine the network traffic information.

In example 21, the subject matter of example 19 or example 20, wherein the decoded control information includes the network traffic information.

In example 22, the subject matter of any one of examples 1 to 21, wherein the processor is further configured to: determine a set of beamforming coefficients; and mix a first baseband signal and a second baseband signal included in a first downlink data stream and a second downlink data stream respectively based on the set of beamforming coefficients to obtain a downlink baseband signal of a UE.

In example 23, the subject matter of example 22, wherein the first downlink data stream is received from a first O-DU of the plurality of O-DUs and the second downlink data stream is received from a second O-DU of the plurality of O-DUs.

In example 24, the subject matter of example 22 or example 23, wherein the processor is further configured to cause the interface to communicate a downlink data stream including the downlink baseband signal of the UE to a corresponding O-RU of the plurality of O-RUs.

In example 25, the subject matter of any one of examples 22 to 24, wherein the processor is configured to determine a beamforming matrix including the set of beamforming coefficients.

In example 26, the subject matter of example 25, wherein the beamforming matrix is determined based on a received message from the first O-DU and/or the second O-DU.

In example 27, the subject matter of example 26, wherein the received message further includes an indication of at least one of the first baseband signal and/or the second baseband signal.

In example 28, the subject matter of any one of examples 22 to 27, wherein the processor includes an accelerator configured to mix the first baseband signal and the second baseband signal with a matrix multiplication operation.

In example 29, the subject matter of any one of examples 1 to 28, wherein the network unit pair is determined based on received control information from at least one of the plurality of O-RUs and/or the plurality of O-DUs.

In example 30, the subject matter of any one of examples 1 to 29, wherein the interface includes a plurality of O-RU fronthaul communication circuits, each O-RU fronthaul communication circuit is configured to transmit and/or receive a data stream to/from a respective O-RU of the plurality of O-RUs.

In example 31, the subject matter of any one of examples 1 to 30, wherein the interface includes a plurality of O-DU fronthaul communication circuits, each O-DU fronthaul communication circuit is configured to transmit and/or receive a data stream to/from a respective O-DU of the plurality of O-DUs.

In example 32, an apparatus of a disaggregated radio access network, the apparatus including: an interface configured to communicate between a plurality of radio units and a plurality of baseband processing units of the disaggregated radio access network; a processor configured to: select, to establish a network unit pair, a radio unit from the plurality of radio units; select, for the network unit pair, a baseband processing unit from the plurality of baseband processing units; route a data stream of a mobile radio communication device between the network unit pair for communication of the mobile radio communication device.

In example 33, the subject matter of example 32, wherein the apparatus is further configured to perform aspects described in any one of the examples 2 to 32.

In example 34, the subject matter include a method of an intermediate node of an open radio access network (O-RAN), the method including: providing communication via an interface between a plurality of O-RAN radio units (O-RUs) and a plurality of O-RAN distributed units (O-DUs); determining a network unit pair including a O-RU of the plurality of O-RUs and a O-DU of the plurality of O-DUs for a data stream of a plurality of data streams to be communicated between the plurality of O-RUs and the plurality of O-DUs; routing, based on the determined network unit pair, the data stream between the O-RUs and the O-DU.

In example 35, the subject matter of example 34, further may include: duplicating an uplink data stream for a transmission to multiple O-DUs of the plurality of O-DUs, wherein the uplink data stream is received from an O-RU of the plurality of O-RUs.

In example 36, the subject matter of example 35, wherein the uplink data stream is addressed to a first O-DU, and the multiple O-DUs includes the first O-DU and at least one second O-DU.

In example 37, the subject matter of example 35 or example 36, further may include: determining the uplink data stream to be duplicated from a plurality of uplink data streams based on a multi user scheduling information.

In example 38, the subject matter of any one of examples 35 to 37, further may include: duplicating the uplink data stream based on control information received from at least one of the plurality of O-RUs and/or the plurality of O-DUs.

In example 39, the subject matter of any one of examples 34 to 38, further may include: changing a first routing of a previously routed data stream between a first network unit pair including one of the plurality of O-RUs and one of the plurality of O-DUs to a second routing between a second network unit pair.

In example 40, the subject matter of example 39,further may include: changing an association of a user equipment (UE) from the first network unit pair to the second network unit pair.

In example 41, the subject matter of example 39 or example 40, wherein the first network unit pair and the second network unit pair include different O-DUs of the plurality of O-DUs.

In example 42, the subject matter of any one of examples 34 to 41, further may include determining a data stream path of a UE based on a O-RU association of the UE; wherein the O-RU association of the UE is determined based on a throughput maximization or a detection error minimization objective.

In example 43, the subject matter of example 42; wherein the O-RU association of the UE is determined jointly across the plurality of O-RUs.

In example 44, the subject matter of example 42 or example 43, further may include determining the O-RU association of the UE by selecting a best estimated O-RU from available O-RUs of the plurality of O-RUs.

In example 45, the subject matter of any one of examples 34 to 44, wherein the network unit pair is determined based on a routing algorithm according to a designated system objective.

In example 46, the subject matter of example 45, wherein the network unit pair is determined based on a maximum number N of RUs of the plurality of O-RUs that are to be associated with the plurality of O-DUs; wherein if the maximum number of O-RUs have been associated with the plurality of O-DUs is exceeded, best performing N O-RUs are selected.

In example 47, the subject matter of example 45 or example 46, wherein O-DU associations for a plurality of UEs served by the plurality of O-RUs are determined iteratively starting from a UE of the plurality of UEs associated with the most O-RUs of the plurality of O-RUs.

In example 48, the subject matter of any one of examples 34 to 47, further may include: determining a power saving unit selectively from at least one of the plurality of O-RUs or the plurality of O-DUs to change an operation mode of the unit.

In example 49, the subject matter of example 48,further may include: encoding a message for a transmission to the power saving unit, wherein the message includes an indication for the power saving unit to operate in a low power mode or to wake up from the low power mode.

In example 50, the subject matter of example 48 or example 49, further may include: routing data streams of a network unit pair including the power saving unit to another network unit pair.

In example 51, the subject matter of any one of examples 48 to 50, further may include: determining the power saving unit based on a received control information representing an identifier of the power saving unit.

In example 52, the subject matter of any one of examples 48 to 51,further may include: determining the power saving unit based on network traffic information representative of an amount of the network traffic associated with the power saving unit and a threshold.

In example 53, the subject matter of example 52, further may include: monitoring the data streams to determine the network traffic information.

In example 54, the subject matter of example 52 or example 53, wherein the decoded control information includes the network traffic information.

In example 55, the subject matter of any one of examples 34 to 54, further may include: determining a set of beamforming coefficients; and mixing a first baseband signal and a second baseband signal included in a first downlink data stream and a second downlink data stream respectively based on the set of beamforming coefficients to obtain a downlink baseband signal of a UE.

In example 56, the subject matter of example 55, wherein the first downlink data stream is received from a first O-DU of the plurality of O-DUs and the second downlink data stream is received from a second O-DU of the plurality of O-DUs.

In example 57, the subject matter of example 55 or example 56, further may include: causing the interface to communicate a downlink data stream including the downlink baseband signal of the UE to a corresponding O-RU of the plurality of O-RUs.

In example 58, the subject matter of any one of examples 55 to 57, further may include: determining a beamforming matrix including the set of beamforming coefficients.

In example 59, the subject matter of example 58, wherein the beamforming matrix is determined based on a received message from the first O-DU and/or the second O-DU.

In example 60, the subject matter of example 59, wherein the received message further includes an indication of at least one of the first baseband signal and/or the second baseband signal.

In example 61, the subject matter of any one of examples 55 to 60, wherein the processor includes an accelerator configured to mix the first baseband signal and the second baseband signal with a matrix multiplication operation.

In example 62, the subject matter of any one of examples 34 to 61, wherein the network unit pair is determined based on received control information from at least one of the plurality of O-RUs and/or the plurality of O-DUs.

In example 63, the subject matter of any one of examples 34 to 62, wherein the interface includes a plurality of O-RU fronthaul communication circuits, each O-RU fronthaul communication circuit is configured to transmit and/or receive a data stream to/from a respective O-RU of the plurality of O-RUs.

In example 64, the subject matter of any one of examples 34 to 63, wherein the interface includes a plurality of O-DU fronthaul communication circuits, each O-DU fronthaul communication circuit is configured to transmit and/or receive a data stream to/from a respective O-DU of the plurality of O-DUs.

In example 65, a method including: communicating via an interface between a plurality of radio units and a plurality of baseband processing units of the disaggregated radio access network; selecting, to establish a network unit pair, a radio unit from the plurality of radio units; selecting, for the network unit pair, a baseband processing unit from the plurality of baseband processing units; routing a data stream of a mobile radio communication device between the network unit pair for communication of the mobile radio communication device.

In example 66, the subject matter of example 65, wherein the apparatus is further configured to perform aspects described in any one of the examples 35 to 64.

In example 67, a non-transitory computer-readable medium including one or more instructions which, if executed by a processor, cause the processor to perform the subject matter of any one of the examples 34 to 66. The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [. . . ] , etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ] , etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of ”or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUs), Distributed Units (DUs) and Centralized Units (CUs).

Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like.

Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

1. An apparatus of an intermediate node of an open radio access network (O-RAN), the apparatus comprising:
an interface configured to provide communication between a plurality of O-RAN radio units (O-RUs) and a plurality of O-RAN distributed units (O-DUs); and
a processor configured to:
determine a network unit pair comprising a O-RU of the plurality of O-RUs and a O-DU of the plurality of O-DUs for a data stream of a plurality of data streams to be communicated between the plurality of O-RUs and the plurality of O-DUs; and
route, based on the determined network unit pair, the data stream between the O-RUs and the O-DU.

2. The apparatus of claim 1,
wherein the processor is configured to duplicate an uplink data stream for a transmission to multiple O-DUs of the plurality of O-DUs, wherein the uplink data stream is received from an O-RU of the plurality of O-RUs.

3. The apparatus of claim 2,
wherein the uplink data stream is addressed to a first O-DU, and the multiple O-DUs comprises the first O-DU and at least one second O-DU.

4. The apparatus of claim 2,
wherein the processor is configured to determine the uplink data stream to be duplicated from a plurality of uplink data streams based on a multi user scheduling information.

5. The apparatus of claim 2,
wherein the processor is configured to duplicate the uplink data stream based on control information received from at least one of the plurality of O-RUs and/or the plurality of O-DUs.

6. The apparatus of claim 1,
wherein the processor is further configured to change a first routing of a previously routed data stream between a first network unit pair comprising one of the plurality of O-RUs and one of the plurality of O-DUs to a second routing between a second network unit pair.

7. The apparatus of claim 6,
wherein the processor is configured to change an association of a user equipment (UE) from the first network unit pair to the second network unit pair.

8. The apparatus of claim 6,
wherein the first network unit pair and the second network unit pair comprise different O-DUs of the plurality of O-DUs.

9. The apparatus of claim 1,
wherein the processor is configured to determine a data stream path of a UE based on a O-RU association of the UE; and
wherein the O-RU association of the UE is determined based on a throughput maximization or a detection error minimization objective.

10. The apparatus of claim 9;
wherein the O-RU association of the UE is determined jointly across the plurality of O-RUs.

11. The apparatus of claim 9,
wherein the processor is further configured to determine the O-RU association of the UE by selecting a best estimated O-RU from available O-RUs of the plurality of O-RUs.

12. The apparatus of claim 1,
wherein the network unit pair is determined based on a routing algorithm according to a designated system objective.

13. The apparatus of any claim 1,
wherein the processor is configured to determine a power saving unit selectively from at least one of the plurality of O-RUs or the plurality of O-DUs to change an operation mode of the unit; wherein the processor is configured to encode a message for a transmission to the power saving unit, wherein the message comprises an indication for the power saving unit to operate in a low power mode or to wake up from the low power mode.

14. (canceled)

15. The apparatus of claim 13,
wherein the processor is configured to route data streams of a network unit pair including the power saving unit to another network unit pair.

16. The apparatus of claim 1,
wherein the processor is further configured to:
determine a set of beamforming coefficients; and
mix a first baseband signal and a second baseband signal included in a first downlink data stream and a second downlink data stream respectively based on the set of beamforming coefficients to obtain a downlink baseband signal of a UE.

17. (canceled)

18. The apparatus of claim 16,
wherein the processor is further configured to cause the interface to communicate a downlink data stream comprising the downlink baseband signal of the UE to a corresponding O-RU of the plurality of O-RUs.
wherein the processor comprises an accelerator configured to mix the first baseband signal and the second baseband signal with a matrix multiplication operation.

19. (canceled)

20. An apparatus of a disaggregated radio access network, the apparatus comprising:
an interface configured to communicate between a plurality of radio units and a plurality of baseband processing units of the disaggregated radio access network; and
a processor configured to:
select, to establish a network unit pair, a radio unit from the plurality of radio units;
select, for the network unit pair, a baseband processing unit from the plurality of baseband processing units; and
route a data stream of a mobile radio communication device between the network unit pair for communication of the mobile radio communication device.

21. The apparatus of claim 20, wherein the processor is further configured to change a first routing of a previously routed data stream between a first network unit pair comprising the selected radio unit of the plurality of radio units and the selected baseband processing unit of the plurality of baseband processing units to a second routing between a second network unit pair.

22. (canceled)

23. (canceled)

24. A non-transitory computer-readable medium comprising one or more instructions which, if executed by a processor, cause the processor to:
provide a communication via an interface configured to provide communication between a plurality of O-RAN radio units (O-RUs) and a plurality of O-RAN distributed units (O-DUs);
determine a network unit pair comprising a O-RU of the plurality of O-RUs and a O-DU of the plurality of O-DUs for a data stream of a plurality of data streams to be communicated between the plurality of O-RUs and the plurality of O-DUs; and
route, based on the determined network unit pair, the data stream between the O-RUs and the O-DU.

25. The non-transitory computer-readable medium of claim 24,
wherein the network unit pair is determined based on received control information from at least one of the plurality of O-RUs and/or the plurality of O-DUs.
